(19) United States
(12) Patent Application Publication
(10) Pub. No.: US 2022/0284327 A1
(43) Pub. Date: Sep. 8, 2022

(54) RESOURCE PUSHING METHOD AND APPARATUS, DEVICE, AND STORAGE MEDIUM

(71) Applicant: Tencent Technology (Shenzhen) Company Limited, Shenzhen (CN)

(72) Inventors: Shaoliang ZHANG, Shenzhen (CN); Rui Wang, Shenzhen (CN); Ruobing Xie, Shenzhen (CN); Zhihong Yang, Shenzhen (CN); Feng Xia, Shenzhen (CN); Leyu Lin, Shenzhen (CN)

(21) Appl. No.: 17/725,429

(22) Filed: Apr. 20, 2022

Related U.S. Application Data
(63) Continuation of application No. PCT/CN2021/094380, filed on May 18, 2021.

(30) Foreign Application Priority Data
May 29, 2020 (CN) 202010478144.3

(51) Int. Cl. G06N 5/04; G06F 16/9535; G06N 5/02

(52) U.S. Cl. CPC G06N 5/04; G06F 16/9535; G06N 5/022

(57) ABSTRACT

This application discloses a resource pushing method performed by a computer device. The method includes: obtaining a target recommendation model and a preference feature and a candidate resource set corresponding to a target object, the preference feature including at least a channel preference feature and a content preference feature; obtaining at least one target resource from the candidate resource set based on the target recommendation model and the preference feature; and pushing the at least one target resource to the target object. Such a resource pushing process integrates preferences of the target object in different dimensions, so that the target resource pushed to the target object not only conforms to channel preferences of the target object, but also conforms to content references of the target object, which is beneficial to improving the resource pushing effect, and further increasing the click-through rates (CTRs) of the pushed resources.

### CROSS-REFERENCE TO RELATED APPLICATIONS

This application is a continuation application of PCT Patent Application No. PCT/CN2021/094380, entitled “RESOURCE PUSHING METHOD AND APPARATUS, DEVICE, AND STORAGE MEDIUM” filed on May 18, 2021, which claims priority to Chinese Patent Application No. 202010478144.3, filed with the State Intellectual Property Office of the People's Republic of China on May 29, 2020, and entitled “CONTENT RECOMMENDATION METHOD AND APPARATUS, DEVICE, AND STORAGE MEDIUM”, all of which are incorporated herein by reference in their entirety.

### FIELD OF THE TECHNOLOGY

Embodiments of this application relate to the field of artificial intelligence, and in particular, to a resource pushing method and apparatus, a device, and a storage medium.

### BACKGROUND OF THE DISCLOSURE

With the rapid development of artificial intelligence (AI) technologies, in an increasing quantity of application scenarios, personalized resources, such as athletic competition videos, English teaching audio, and current news articles, are pushed to users by using the AI technologies, so as to improve the interaction experience of the users.

In the related art, in processes of pushing resources to users, click-through rates (CTRs) of candidate resources are first predicted, then, the candidate resources are sorted according to the predicted CTRs, and top-ranked resources are pushed to the users. In such processes of pushing resources, the candidate resources are directly sorted according to the predicted CTRs, where limited information is taken into consideration, and effects of the resource pushing are poor, resulting in relatively low CTRs of the pushed resources.

### SUMMARY

Embodiments of this application provide a resource pushing method and apparatus, a device, and a storage medium, to improve a resource pushing effect, and further increase CTRs of pushed resources. The technical solutions are as follows.

According to an aspect, an embodiment of this application provides a resource pushing method performed by a computer device, the method including:

obtaining a preference feature and a candidate resource set corresponding to a target object, the preference feature including at least a channel preference feature and a content preference feature, and the candidate resource set including at least one candidate resource;

obtaining at least one target resource from the candidate resource set based on the preference feature; and

pushing the at least one target resource to the target object.

A resource pushing method is further provided, performed by a computer device, the method including:

obtaining a target recommendation model and a preference feature and a candidate resource set corresponding to a target object, the preference feature including at least a channel preference feature and a content preference feature, the target recommendation model including a first target recommendation model and a second target recommendation model, and the candidate resource set including at least one candidate resource;

obtaining at least one target resource from the candidate resource set based on the target recommendation model and the preference feature; and

pushing the at least one target resource to the target object.

According to another aspect, a computer device is provided, including a processor and a memory, the memory storing at least one segment of program code, the at least one segment of program code being loaded and executed by the processor, to cause the computer device to implement the resource pushing method according to any one of the foregoing.

According to another aspect, a non-transitory computer-readable storage medium is further provided, storing at least one segment of program code, the at least one segment of program code being loaded and executed by a processor of a computer device, to cause the computer device to implement the resource pushing method according to any one of the foregoing.

In the embodiments of this application, at least one target resource is obtained and pushed to a target object based on a preference feature including a channel preference feature and a content preference feature. In such a resource pushing process, the channel preference feature reflects channel information, and the content preference feature reflects content information. The resource pushing process integrates preferences of the target object in different dimensions, so that the pushed target resource not only conforms to channel preferences of the target object, but also conforms to content references of the target object, which is beneficial to improving the resource pushing effect, and further increasing the CTRs of the pushed resources.

### BRIEF DESCRIPTION OF THE DRAWINGS

FIG. 1 is a schematic diagram of a reinforcement learning process according to an embodiment of this application.

FIG. 2 is a schematic diagram of an implementation environment of a resource pushing method according to an embodiment of this application.

FIG. 3 is a flowchart of a resource pushing method according to an embodiment of this application.

FIG. 4 is a schematic diagram of a process of displaying a pushed page on a terminal screen according to an embodiment of this application.

FIG. 5 is a schematic diagram of a process of obtaining a target resource sequence according to an embodiment of this application.

FIG. 6 is a flowchart of a resource pushing method according to an embodiment of this application.

FIG. 7 is a flowchart of a method for training an initial recommendation model according to an embodiment of this application.

FIG. 8 is a schematic diagram of a resource pushing apparatus according to an embodiment of this application.

FIG. 9 is a schematic diagram of a resource pushing apparatus according to an embodiment of this application.

FIG. 10 is a schematic diagram of a resource pushing apparatus according to an embodiment of this application.

FIG. 11 is a schematic structural diagram of a server according to an embodiment of this application.

FIG. 12 is a schematic structural diagram of a terminal according to an embodiment of this application.

### DESCRIPTION OF EMBODIMENTS

To make the objectives, technical solutions, and advantages of this application clearer, the following further describes implementations of this application in detail with reference to the accompanying drawings.

AI is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology of computer science. AI attempts to understand the essence of intelligence and produce a new type of intelligent machine that can react in a similar way to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, an audio processing technology, machine learning (ML)/deep learning, and a natural language processing technology.

ML is a multi-field interdisciplinary subject involving the probability theory, statistics, the approximation theory, convex analysis, the algorithm complexity theory, and the like. The ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. The ML and deep learning generally include technologies such as an artificial neural network, a belief network, reinforcement learning, transfer learning, inductive learning, and learning from demonstrations. The reinforcement learning is a field of ML and emphasizes how to act based on an environment to maximize expected benefits. Deep reinforcement learning is a combination of deep learning and reinforcement learning, and the deep learning technology is used to resolve reinforcement learning problems.

Reinforcement learning is an optimal policy of learning, which can cause an agent in a specific environment to make an action according to a current state, so as to obtain a maximum reward.

Reinforcement learning can be modeled simply by using a quadruple <A, S, R, P>. A represents an action, which is an action made by an agent. A state is a state of a world that the agent can perceive. A reward is a real value representing a reward or a punishment. P is an environment with which the agent interacts.

Influence relationships between elements in the quadruple <A, S, R, P> are as follows:

Action space: A, that is, all actions A form an action space.

State space: S, that is, all states S form a state space.

Reward: S*A*S′→R, that is, in a current state S, after an action A is performed, the current state changes to S′, and a reward R corresponding to the action A is obtained.

Transition: S*A→S′, that is, in a current state S, after an action A is performed, the current state changes to S′.

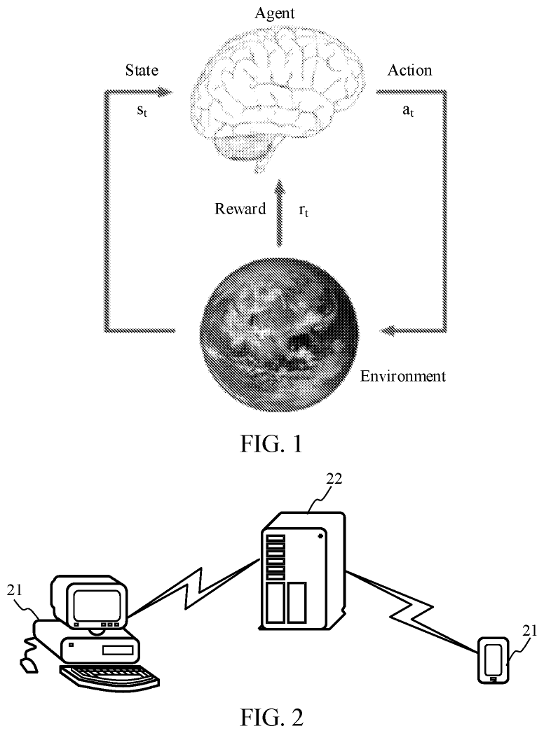

In fact, a reinforcement learning process is continuously iterating process. As shown in FIG. 1, in a continuously iterating process, an agent performs an action at after receiving and obtaining a state sₜ and a reward rₜ fed back by an environment. The environment outputs, after receiving the action at performed by the agent, a state sₜ₊₁ and a reward rₜ₊₁ fed back by the environment. The recommendation models used in the embodiments of this application are trained based on the reinforcement learning algorithm.

FIG. 2 shows a schematic diagram of an implementation environment of a resource pushing method according to an embodiment of this application. The implementation environment may include a terminal 21 and a server 22.

An application program or a web page capable of pushing a resource to a target object is installed on the terminal 21. The application program or web page can push a resource to a target object based on the method provided in the embodiments of this application. In the embodiments of this application, a resource that can be pushed includes, but is not limited to, a long video about a specific content, a short video about a specific content, an article about a specific content, and one or more resources are simultaneously pushed to a target object. In a process of pushing a resource to a target object, the terminal 21 can obtain a channel preference feature, a content preference feature, and a candidate resource set corresponding to the target object, and then obtain at least one target resource and push the at least one target resource to the target object. Certainly, the server 22 can also obtain a channel preference feature, a content preference feature, and a candidate resource set corresponding to the target object, and then obtain at least one target resource. After obtaining the at least one target resource, the server 22 sends the at least one target resource the terminal 21. The terminal 21 pushes the at least one target resource to the target object.

In one implementation, the terminal 21 is an electronic product that can perform human computer interaction with a user in one or more manners such as a keyboard, a touchpad, a touchscreen, a remote control, voice interaction, or a handwriting device, for example, a personal computer (PC), a mobile phone, a personal digital assistant (PDA), a wearable device, a pocket PC (PPC), a tablet computer, a smart car, a smart TV, or a smart speaker. The server 22 may be one server, a server cluster including a plurality of servers, or a cloud computing service center. The terminal 21 and the server 22 establish a communication connection through a wired or wireless network.

A person skilled in the art is to understand that the terminal 21 and server 22 are only examples, and other existing or potential terminals or servers that are applicable to this application are also to be included in the scope of protection of this application, and are included herein by reference.

Comprehensive pushing faces the following challenges: 1. Heterogeneous resources corresponding to different channels usually have different features and sorting policies, which makes different resources incomparable in terms of sorting and scoring. 2. An interaction object not only has personalized preferences for different contents, but also has personalized preferences for different channels. 3. Online comprehensive pushing in the industry pays great attention to the robustness and stability of a system. A small fluctuation on a channel may exert huge impact on the performance of an entire push system.

At present, in most cases of comprehensive pushing, heterogeneous resources are sorted together in a CTR-oriented manner, or recommendation is performed based on rules. However, the CTR-oriented manner may cause homogenized channels and contents, and further affect the long-term experience of the interaction object. Setting rules using experience may inevitably degrade the personalization of recommendation. In the embodiments of this application, the comprehensive pushing is divided into two sub-tasks to perform channel recommendation and content recommendation respectively. For example, a first target recommendation model, serving as a channel selector, obtains a personalized channel. A second target recommendation model, serving as a content recommender, recommends a corresponding content under a specific channel, and obtains a final target resource. The foregoing problems are resolved by efficiently and flexibly capturing personalized preferences of the interaction object for channels and contents, thereby optimizing the entire effect of the comprehensive pushing.

An application scenario of resource pushing is not limited in the embodiments of this application. Illustratively, the application scenario may be a scenario of pushing a feed stream (a type of information flow). The feed stream is an information flow continuously updated and presenting contents to an interaction object. Feed stream pushing is resource pushing of a type of aggregate information, where feeds are propagated to a subscriber in real time by using a feed stream, and is an effective manner in which the interaction object obtains an information flow. Certainly, the embodiments of this application not only can be applied to comprehensive pushing of a feed stream, but also can be applied to other push scenarios including heterogeneous resources. In addition, the main idea herein is to divide the problem of comprehensive pushing including heterogeneous resources into two parts by using a hierarchical recommendation method. For example, a channel is recommended first, and then, to-be-pushed resources are obtained under the constraint of the channel. Alternatively, a content is recommended first, and then, a to-be-pushed resource is obtained under the constraint of the recommended content.

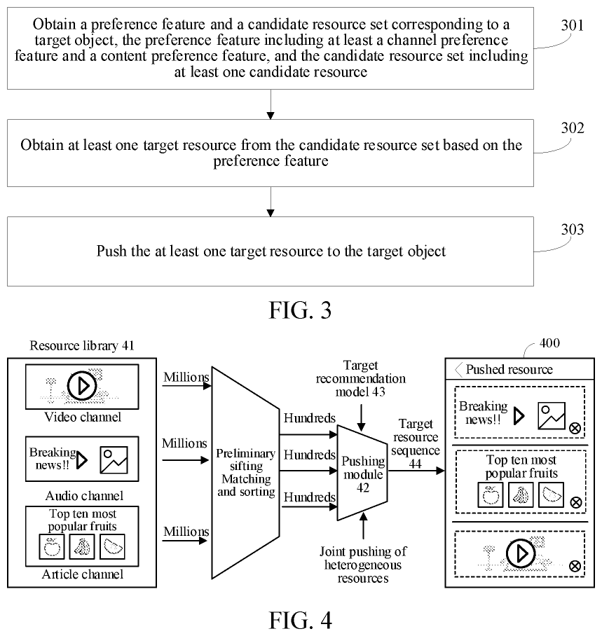

Based on the implementation environment shown in FIG. 2, the embodiments of this application provide a resource pushing method, performed by a computer device. The computer device may be the terminal 21 or the server 22. In the embodiments of this application, descriptions are provided by using an example in which the resource pushing method is applied to the terminal 21. As shown in FIG. 3, the resource pushing method provided in this embodiment of this application includes step 301 to step 303:

Step 301: Obtain a preference feature and a candidate resource set corresponding to a target object, the preference feature including at least a channel preference feature and a content preference feature, and the candidate resource set including at least one candidate resource.

The target object is an interaction object that needs the terminal to push a resource. In the embodiments of this application, there may be various contents of the resource and various presentation forms of the content. For example, the content includes, but is not limited to, an athletic competition, English teaching, current news, delicacy introduction, and the like. The presentation form of the content includes, but is not limited to, a short video, a long video, audio, an article, and the like. The resource includes, but is not limited to, an athletic competition content presented in the form of a short video, an English teaching content presented in the form of audio, and the like. Exemplarily, the athletic competition content presented in the form of a short video may also be referred to as an athletic competition short video, and the English teaching content presented in the form of audio may also be referred to as English teaching audio.

In the embodiments of this application, a presentation form of the content of the resource is indicated by using a channel corresponding to the resource, and the channel is used for integrating contents having the same presentation form. For example, two resources, delicacy introduction presented in the form of a short video and an athletic competition presented in the form of a short video, both correspond to a short video channel. That is, in the embodiments of this application, a resource has attributes in two aspects, namely, the channel and the content. A channel corresponding to a resource is used for indicating a presentation form of a content of the resource. In some embodiments, the channel is displayed in an application program in the form of an entry, and the target object can switch the channel by clicking/tapping a corresponding entry.

Resources corresponding to a same channel are isomorphic resources, that is, resources in a same presentation form. Resource corresponding to different channels are heterogeneous resources, that is, resources in different presentation forms. In the embodiments of this application, resources that can be pushed may include both isomorphic resources and heterogeneous resources. When the resources that can be pushed include heterogeneous resources, resources in different presentation forms can be pushed for the target object, so that the diversity of the pushed resource and the interaction experience of the target object are improved. When the resources that can be pushed include heterogeneous resources, a pushing process is referred to as a comprehensive pushing process. Comprehensive pushing refers to pushing heterogeneous resources corresponding to different channels to the target object.

An application program or a web page capable of pushing resources is installed on a terminal. When the target object opens the application program or the web page, a pushed-resource obtaining request is transmitted in the application program or the web page, to obtain pushed resources and browse the pushed resources. In an exemplary embodiment, in the embodiments of this application, a process of obtaining pushed resources may be performed based on a pushed-resource obtaining request, or may be performed based on a preset trigger condition, which is not limited in the embodiments of this application. For example, the preset trigger condition refers to performing a process of obtaining pushed resources every time a preset trigger time interval is passed.

In a process of pushing resources, the terminal first obtains a preference feature corresponding to the target object and a candidate resource set. The preference feature and candidate resource set obtained herein are both obtained for the target object. That is, the process of pushing resources is a personalized pushing process for an interaction object.

In the embodiments of this application, the preference feature corresponding to the target object includes, but is not limited to, a channel preference feature and a content preference feature. The channel preference feature is used for representing a channel preference of the target object, and the content preference feature is used for representing a content preference of the target object. In one implementation, the process of obtaining a channel preference feature and a content preference feature corresponding to the target object includes step 1-1 to step 1-3 as follows:

Step 1-1: Obtain at least one historical pushed resource corresponding to the target object.

For example, the at least one historical pushed resource is sequentially arranged to constitute a historical pushed resource sequence. The historical pushed resource refers to a resource that has been pushed to the target object. For example, the historical pushed resource is obtained from a historical behavior log of the target object. A quantity of the historical pushed resources, a condition that the historical pushed resource needs to meet, and a requirement on an arrangement order of the historical pushed resources may be set according to experience, or may be adjusted flexibly according to an application scenario, which are not limited in the embodiments of this application.

For example, the quantity of the historical pushed resources is set to 50, and the condition that the historical pushed resource needs to meet is that a time interval between a push time stamp and a current time stamp does not exceed a time interval threshold. When the quantity of the historical pushed resources is 50, the at least one historical pushed resource may be limited by adjusting the time interval threshold to 50 historical pushed resources recently pushed to the target object.

For example, not all historical pushed resources may be triggered (for example, being clicked/tapped for reading or viewing) by the target object. The conditions that the historical pushed resource needs to meet are set to be that a time interval between a pushing time stamp and a current time stamp does not exceed a time interval threshold and being triggered by the target object, to improve the accuracy of the determined channel preference feature and content preference feature.

For example, the arrangement order of the historical pushed resources refers to a sequential order of pushing time stamps of the historical pushed resource. For example, when a plurality of historical pushed resources are pushed at the same time, a sequential order of positions of the plurality of historical pushed resources on a terminal screen is used as an arrangement order of the plurality of historical pushed resources with a same pushing time stamp.

Step 1-2: Obtain a channel feature sequence and a content feature sequence based on the at least one historical pushed resource.

The channel feature sequence is constituted by at least one channel feature that is sequentially arranged, and the content feature sequence is constituted by at least one content feature that is sequentially arranged. A quantity of channel features and a quantity of content features are both the same as a quantity of the historical pushed resources. That is, a channel feature and a content feature are both obtained based on each historical pushed resource. For example, a channel feature sequence is represented as Seq₁^{l}={f₁^{l}, f₂^{l}, . . . , fₘ^{l}}, where Seq₁^{l} represents the channel feature sequence, m (m is an integer greater than or equal to 1) represents a quantity of historical pushed resources, and fₘ^{l} represents a channel feature at the m^{th} arrangement position in the channel feature sequence. For example, a content feature sequence is represented as Seq₁^{h}={f₁^{h}, f₂^{h}, . . . , fₘ^{h}}, where Seq₁^{h} represents the content feature sequence, m represents a quantity of historical pushed resources, and fₘ^{h} represents a content feature at the m^{th} arrangement position in the content feature sequence.

In one implementation, the process of obtaining a channel feature sequence and a content feature sequence based on the at least one historical pushed resource includes step a to step d as follows:

Step a: Obtain basic information, channel information, and content information corresponding to the historical pushed resource;

For example, the at least one historical pushed resource is sequentially arranged to constitute a historical pushed resource sequence. That is, each historical pushed resource in the at least one historical pushed resource has an arrangement position. For each historical pushed resource in the at least one historical pushed resource, relevant information corresponding to the historical pushed resource is obtained, to further obtain a channel feature and a content feature corresponding to the historical pushed resource by using the relevant information of the historical pushed resource.

In the embodiments of this application, the relevant information corresponding to the historical pushed resource includes, but is not limited, basic information, channel information, and content information. The basic information includes at least one of user portrait information or environment information, the channel information includes at least one of basic channel information or accumulated channel information, and the content information includes at least one of basic content information or accumulated content information. The user portrait information, environment information, basic channel information, accumulated channel information, basic content information, and accumulated content information corresponding to the historical pushed resource are respectively described below:

The user portrait information is obtained based on a user portrait of the target object. For example, the user portrait information includes basic attribute information (for example, the age, gender, home address, post, and social relationships), interest or preference information (for example, favorite topics, tags, and categories) and cross information of the target object. In a process in which the target object and the terminal continuously interacts with each other, the terminal may construct and continuously update the user portrait of the target object. For example, user portrait information corresponding to a historical pushed resource is extracted from a user portrait that has been constructed by the terminal when the historical pushed resource is pushed.

The environment information refers to information about a pushing environment when the historical pushed resource is pushed. The environment information includes, but is not limited, to a device type of the terminal (for example, an IOS mobile phone, an Android mobile phone, or a computer), a network type (for example, a 4G network or a wireless fidelity Wi-Fi) network), a time factor (for example, a pushing time stamp), a position of the terminal, and the like. For example, the environment information corresponding to the historical pushed resource is obtained and stored when the historical pushed resource is pushed. In this case, the environment information corresponding to the historical pushed resource can be directly extracted from a storage.

The basic channel information refers to information about the historical pushed resource on a channel level, and is used for indicating a presentation form of a content of the historical pushed resource. For example, when the historical pushed resource is a product introduction presented in the form of short video, the channel information corresponding to the historical pushed resource is used for indicating a short video channel. For example, the basic channel information is an identifier, a name, or a feature of a channel corresponding to the historical pushed resource, which is not limited in the embodiments of this application. For example, the basic channel information corresponding to the historical pushed resource is stored in correspondence with the historical pushed resource. When the historical pushed resource is obtained, the basic channel information corresponding to the historical pushed resource can be obtained.

The content information refers to information about the historical pushed resource on a content level. In one implementation, the content information corresponding to the historical pushed resource includes, but is not limited to, classification information (for example, a tag, a category, and a topic of the content of the historical pushed resource), popularity information, temporality, a resource provider, and cross information of the content of the historical pushed resource. For example, the content information corresponding to the historical pushed resource is stored in correspondence with the historical pushed resource. When the historical pushed resource is obtained, the content information corresponding to the historical pushed resource can be obtained.

The accumulated channel information is used for representing a channel preference of the target object to some extent. In one implementation, a manner of obtaining the accumulated channel information corresponding to the historical pushed resource is: using, in a historical pushed resource sequence, historical pushed resources of which arrangement positions are before that of the historical pushed resource as previous historical pushed resources corresponding to the historical pushed resource; and obtaining the accumulated channel information corresponding to the historical pushed resource based on trigger situations of channels corresponding to the previous historical pushed resources. For example, a trigger situation of a channel is used for indicating whether the target object triggers the channel.

In one implementation, a process of obtaining the accumulated channel information corresponding to the historical pushed resource based on trigger situations of channels corresponding to the previous historical pushed resources is: collecting statistics on at least one of quantities of times of being triggered or proportions of being triggered of the channels based on the trigger situations of the channels corresponding to the previous historical pushed resources, and using the statistical information as the accumulated channel information corresponding to the historical pushed resource.

The accumulated content information is used for representing a content preference of the target object to some extent. In one implementation, a manner of obtaining the accumulated content information corresponding to the historical pushed resource is: using, in a historical pushed resource sequence, historical pushed resources of which arrangement positions are before that of the historical pushed resource as previous historical pushed resources corresponding to the historical pushed resource; and obtaining the accumulated content information corresponding to the historical pushed resource based on trigger situations of contents of the previous historical pushed resources. For example, a trigger situation of a content is used for indicating whether the target object triggers the content.

In one implementation, a process of obtaining the accumulated content information corresponding to the historical pushed resource based on trigger situations of contents of the previous historical pushed resources is: collecting statistics on at least one of quantities of times of being triggered or proportions of being triggered of content tags based on the trigger situations of the contents corresponding to the previous historical pushed resources, and using the statistical information as the accumulated content information corresponding to the historical pushed resource. The content tag is used for representing relevant information, such as a category and a topic, of a content. One historical pushed resource corresponds to one or more content tags.

For example, when the historical pushed resource in the historical pushed resource sequence is located at the i^{th} (i is an integer greater than or equal to 1 and less than or equal to m) arrangement position (that is, is located at the i^{th} position), user portrait information, environment information, basic channel information, basic content information, accumulated channel information, and accumulated content information corresponding to the historical pushed resource are respectively represented as fᵤₛₑᵣ_{ᵢ}, f_{context}_{ᵢ}, f_{channel}_{ᵢ}^{l}, fᵢₜₑₘ_{ᵢ}^{h}, f_{cumu}^{l}, and f_{cumu}_{ᵢ}^{h}. The basic information corresponding to the historical pushed resource includes at least one of fᵤₛₑᵣ_{ᵢ} or f_{context}_{ᵢ}. The channel information corresponding to the historical pushed resource includes at least one of f_{channel}_{ᵢ}^{l} or f_{cumu}_{ᵢ}^{l}. The content information corresponding to the historical pushed resource includes at least one of fᵢₜₑₘ_{ᵢ}^{h} or f_{cumu}_{ᵢ}^{h}. The basic information and channel information corresponding to the historical pushed resource are used for obtaining a channel feature corresponding to the historical pushed resource. See step b for the obtaining process. The basic information and content information corresponding to the historical pushed resource are used for obtaining a content feature corresponding to the historical pushed resource. See step c for the obtaining process.

Step b: Perform fusion processing on the basic information and channel information corresponding to the historical pushed resource, to obtain a channel feature corresponding to the historical pushed resource.

The basic information and channel information corresponding to the historical pushed resource are original channel information. The original channel information can be fully used by performing fusion processing on the basic information and channel information corresponding to the historical pushed resource. A feature obtained after the fusion processing is used as a channel feature corresponding to the historical pushed resource.

A fusion processing process is not limited in the embodiments of this application provided that a fused feature can be obtained by taking pieces of information into comprehensive consideration. For example, a manner of performing fusion processing on the basic information and channel information corresponding to the historical pushed resource, to obtain a channel feature corresponding to the historical pushed resource is: constructing a first feature matrix based on the basic information and channel information corresponding to the historical pushed resource; extracting a first parameter, a second parameter, and a third parameter based on the first feature matrix; calculating first head information by using the first parameter, the second parameter, and the third parameter; and calculating the channel feature corresponding to the historical pushed resource based on the first head information.

Quantities of the first parameters, the second parameters, the third parameters, and the pieces of first head information are the same and are all one or more than one. The first parameter, the second parameter, and the third parameter have the same dimension. It is assumed that the first feature matrix constructed based on the basic information and channel information corresponding to the historical pushed resource is \hat{F}ᵢ^{l}. A process of extracting the first parameter (which is Q, query, in an attention mechanism), the second parameter (which is K, key, in the attention mechanism), and the third parameter (which is V, value, in the attention mechanism) based on the first feature matrix is implemented based on a formula 1, a process of calculating first head information by using the first parameter, the second parameter, and the third parameter is implemented based on a formula 2, and a process of calculating the channel feature corresponding to the historical pushed resource based on the first head information is implemented based on a formula 3:

$${Q}_{j} = {W}_{j}^{Q} {\hat{F}}_{i}^{l} \\ {K}_{j} = {W}_{j}^{K} {\hat{F}}_{i}^{l} \\ {V}_{j} = {W}_{j}^{V} {\hat{F}}_{i}^{l} \qquad ( formula 1 )$$

$${head}_{j} = soft max ( \frac{{Q}_{j}^{\cdot } {K}_{j}}{\sqrt{{d}_{h}}} ) {V}_{j} \qquad ( formula 2 )$$

$${f}_{i}^{l} = MultiHead ( {\hat{F}}_{i}^{l} ) = concat ( {head}_{1} , … , {head}_{h} ) \cdot {w}^{O} \qquad ( formula 3 )$$

where Qⱼ represents the j^{th} (integer greater than or equal to 1) first parameter; Kⱼ represents the j^{th} second parameter; Vⱼ represents the j^{th} third parameter; headⱼ represents the j^{th} piece of first head information; Wⱼ^{Q}, Wⱼ^{K}, and Wⱼ^{V} represent a projection matrix of the j^{th} piece of first head information; dₕ represents the dimension of the first parameter; softmax represents a function; fᵢ^{l} represents a channel feature corresponding to a historical pushed resource located at the i^{th} position in the historical pushed resource sequence; MultiHead represents a multi-head self-attention feature interaction operation; concat represents a concatenation operation; and w^{O} represents a weight vector (w^{O} belongs to a dₕ-dimensional Euclidean space, that is, w^{O}∈ [symbol] ^{d}^{ₕ}).

Step c: Perform fusion processing on the basic information and content information corresponding to the historical pushed resource, to obtain a content feature corresponding to the historical pushed resource.

The basic information and content information corresponding to the historical pushed resource are original content information. The original content information can be fully used by performing fusion processing on the basic information and content information corresponding to the historical pushed resource. A feature obtained after the fusion processing is used as a content feature corresponding to the historical pushed resource.

For example, a manner of performing fusion processing on the basic information and content information corresponding to the historical pushed resource, to obtain a content feature corresponding to the historical pushed resource is: constructing a second feature matrix based on the basic information and content information corresponding to the historical pushed resource; extracting a fourth parameter (Q), a fifth parameter (K), and a sixth parameter (V) based on the second feature matrix; calculating second head information by using the fourth parameter, the fifth parameter, and the sixth parameter; and calculating the content feature corresponding to the historical pushed resource based on the second head information. Dereference may be made to step b for the implementation process, which is not described herein in detail again. Through such a process, the content feature corresponding to the historical pushed resource can be represented as fᵢ^{h}=MultiHead(\hat{F}ᵢ^{h}), where fᵢ^{h} represents a content feature corresponding to a historical pushed resource located at the i^{th} position in the historical pushed resource sequence; \hat{F}ᵢ^{h} represents a second feature matrix; and MultiHead represents a multi-head self-attention feature interaction operation.

Step d: Arrange, according to an arrangement order of historical pushed resources, channel features respectively corresponding to the historical pushed resources, to obtain the channel feature sequence; and arrange, according to the arrangement order of the historical pushed resources, content features respectively corresponding to the historical pushed resources, to obtain the content feature sequence.

According to step a and step b, channel features respectively corresponding to the historical pushed resources can be obtained, thereby obtaining a channel feature sequence based on the channel features respectively corresponding to the historical pushed resources. In one implementation, a process of obtaining a channel feature sequence based on the channel features respectively corresponding to the historical pushed resources is: arranging, according to an arrangement order of historical pushed resources in the historical pushed resource sequence, channel features respectively corresponding to the historical pushed resources, to obtain the channel feature sequence. That is, a channel feature located at a specific arrangement position in the channel feature sequence corresponds to a historical pushed resource located at a same arrangement position in the historical pushed resource sequence.

According to step a and step c, content features respectively corresponding to the historical pushed resources can be obtained, thereby obtaining a content feature sequence based on the content features respectively corresponding to the historical pushed resources. In one implementation, a process of obtaining a content feature sequence based on the content features respectively corresponding to the historical pushed resources is: arranging, according to an arrangement order of historical pushed resources in the historical pushed resource sequence, content features respectively corresponding to the historical pushed resources, to obtain the content feature sequence. That is, a content feature located at a specific arrangement position in the content feature sequence corresponds to a historical pushed resource located at a same arrangement position in the historical pushed resource sequence.

A channel feature sequence and a content feature sequence can be obtained according to step a to step d. Step 1-3 is performed.

Step 1-3: Process the channel feature sequence, to obtain a channel preference feature corresponding to the target object; and process the content feature sequence, to obtain a content preference feature corresponding to the target object.

The channel feature sequence is used for obtaining the channel preference feature corresponding to the target object. In an exemplary embodiment, the process of processing the channel feature sequence, to obtain a channel preference feature corresponding to the target object is invoking a first processing model to process the channel feature sequence, to obtain the channel preference feature corresponding to the target object.

The first processing model is configured to process the channel feature sequence. Because the channel feature sequence is constituted by at least one channel feature that is sequentially arranged, in a process of processing the channel feature sequence, not only the channel features are considered, but also association relationships between the channel features are considered. A structure of the first processing model is not limited in the embodiments of this application. For example, the first processing model is a Gated Recurrent Unit (GRU) model. The process of invoking the first processing module to process the channel feature sequence, to obtain a channel preference feature corresponding to the target object is implemented based on a formula 4:

$${s}_{1}^{l} = {GRU}^{l} ( {Seq}_{1}^{l} ) \qquad ( formula 4 )$$

where s₁^{l} represents a channel preference feature corresponding to the target object; GRU^{l} represents a first processing model; and Seq₁^{l} represents a channel feature sequence.

The content feature sequence is used for obtaining the content preference feature corresponding to the target object. In an exemplary embodiment, the process of processing the content feature sequence, to obtain a content preference feature corresponding to the target object is invoking a second processing model to process the content feature sequence, to obtain the content preference feature corresponding to the target object.

The second processing model is configured to process the content feature sequence. Because the content feature sequence is constituted by at least one content feature that is sequentially arranged, in a process of processing the content feature sequence, not only the content features are considered, but also association relationships between the content features are considered. A structure of the second processing model is not limited in the embodiments of this application. For example, the second processing model is also a GRU model. The process of invoking the second processing module to process the content feature sequence, to obtain a content preference feature corresponding to the target object is implemented based on a formula 5:

$${s}_{1}^{h} = {GRU}^{h} ( {Seq}_{1}^{h} ) \qquad ( formula 5 )$$

where s₁^{h} represents a content preference feature corresponding to the target object; GRU^{h} represents a second processing model; and Seq₁^{h} represents a content feature sequence.

When structures of the first processing model and the second processing model are the same, parameters of the first processing model and the second processing model may be the same or different, which is not limited in the embodiments of this application.

The process of obtaining a channel preference feature and a content preference feature corresponding to the target object is described above in step 1-1 to step 1-3. For example, in addition to including the channel preference feature and the content preference feature, the preference feature corresponding to the target object may further include another preference feature such as a song preference feature, which is not limited in the embodiments of this application.

A process of obtaining a candidate resource set corresponding to a target object is described below:

The candidate resource set includes at least one candidate resource. The process of obtaining a candidate resource set is a process of obtaining candidate resources. In one implementation, the process of obtaining a candidate resource set corresponding to a target object is: performing preliminary sifting on all resources in a resource library based on historical behavior information of the target object, and grouping, according to channels, resources obtained through preliminary sifting, to obtain resource groups corresponding to the channels; sorting resources in a resource group corresponding to each channel according to degrees of matching the target object; using first quantities of top-ranked resources in the resource groups as candidate resources; and using a set of the candidate resources as the candidate resource set.

For different resource groups, the first quantities may be set differently or uniformly. For example, for different resource groups, if the first quantities are uniformly set to 200, 200 top-ranked resources in the resource groups are used as candidate resources. A preliminary sifting rule and a manner of calculating a degree of matching the target object are not limited in the embodiments of this application and can be flexibly set according to an application scenario.

For example, the preliminary sifting rule is deleting a content of which a time interval between a resource generation time stamp and a current time stamp exceeds a first threshold. For example, the manner of calculating a degree of matching between a specific resource and the target object is extracting a feature of the resource based on relevant information of the resource; extracting a feature of the target object based on relevant information of the target object; and using a similarity between the feature of the resource and the feature of the target object as the degree of matching between the resource and the target object.

For example, in obtaining a candidate resource set, each candidate resource corresponds to one candidate channel, and the candidate channel corresponding to the candidate resource is used for indicating a presentation form of a content of the candidate resource. Candidate channels corresponding to different candidate resources may be the same or different. For example, each candidate resource corresponds to one candidate content. The candidate content corresponding to the candidate resource is used for indicating a specific content involved in the candidate resource. For example, one candidate content is represented by using one or more content tags.

Step 302: Obtain at least one target resource from the candidate resource set based on the preference feature.

The preference feature includes, but is not limited to, a channel preference feature and a content preference feature. In a process of obtaining at least one target resource based on the preference feature, a channel preference and a content preference of the target object are taken into comprehensive consideration, so that the obtained target resource fits multi-dimensional preferences of the target object, which is beneficial to improving CTRs of the pushed resources.

In one implementation, an implementation of obtaining at least one target resource from the candidate resource set based on the preference feature is: obtaining at least one target channel from a candidate channel set based on the channel preference feature, one candidate resource corresponding to one candidate channel, and the candidate channel set including candidate channels corresponding to candidate resources in the candidate resource set; and obtaining the at least one target resource from the candidate resource set based on the content preference feature and the at least one target channel. In such an implementation, a target channel is first obtained under the constraint of a channel preference feature, and then, a target resource is obtained under the constraint of both the target channel and the content preference feature.

The channel preference feature is used for obtaining at least one target channel. For example, at least one target channel is sequentially arranged to constitute a target channel sequence. The target channels in the target channel sequence are used for constraining presentation forms of contents of resources that need to be pushed to the target object. The process of obtaining a target channel sequence can be considered as a coarse-grained recommendation process. In such a recommendation process, only channels are recommended. The channels recommended in the coarse-grained recommendation process are only used for constraining a subsequent resource recommendation process, and are not directly pushed to the target object. Through such a process, a task of pushing resources to the target object can be divided into two sub-tasks. The first sub-task is recommending channels, and the second sub-task is recommending resources under the constraint of the recommended channels. In such a manner, not only the content preference of the target object is considered, but also the channel preference of the target object is considered, which is beneficial to improving the resource pushing effect.

The candidate channel set is a set of candidate channels corresponding to the candidate resources in the candidate resource set. Different candidate resources may correspond to a same candidate channel, while the candidate channels included in the candidate channel set are different from each other. For example, after the obtaining at least one target channel from a candidate channel set corresponding to the candidate resource set based on the channel preference feature, at least one target channel is sequentially arranged to constitute a target channel sequence.

In one implementation, the process of the obtaining at least one target channel from a candidate channel set corresponding to the candidate resource set based on the channel preference feature includes step 3021 and step 3022 as follows:

Step 3021: Obtain at least one channel recommendation result based on the channel preference feature.

There is at least one channel recommendation results. Each channel recommendation result is used for indicating a virtual channel. A presentation form of the channel recommendation result is not limited in the embodiments of this application. For example, the channel recommendation result is represented by using one feature vector, and indicates one virtual channel based on the feature vector. The virtual channel herein is relative to real candidate channels in the candidate channel set. The virtual channel may be consistent with a specific candidate channel, or may be consistent with none of the candidate channels. In one implementation, the at least one channel recommendation result constitutes a channel recommendation result sequence.

Step 3022: Use a channel in the candidate channel set matching the at least one channel recommendation result as the target channel.

The channel recommendation result is used for indicating the virtual channel. However, a real channel is to be actually recommended to the target object. Therefore, after the channel recommendation result is obtained, target channels respectively matching the channel recommendation results need to be obtained from the candidate channel set.

In one implementation, a process of obtaining a target channel matching the channel recommendation result from the candidate channel set is: converting candidate channels in the candidate channel set into a presentation form the same as that of the channel recommendation result; respectively calculating similarities between the candidate channels and the channel recommendation result based on the presentation form after the conversion; and using a candidate channel having the highest similarity in the candidate channel set as the target channel matching the channel recommendation result. Because presentation forms of the candidate channels in the candidate channel set may be different from the presentation form of the channel recommendation result, the presentation forms need to be converted first to facilitate similarity calculation. For example, when the presentation form of the channel recommendation result is a feature vector, the candidate channels need to be converted into the presentation form of a feature vector. A manner of calculating a similarity between two vectors is not limited in the embodiments of this application. For example, a cosine similarity between two vectors is used as a similarity between the two vectors.

Certainly, in another possible implementation, the channel recommendation result can alternatively be converted into a presentation form the same as those of the candidate channels. Therefore, similarities between the channel recommendation result with the presentation form converted and the candidate channels are determined, and further, a candidate channel with the highest similarity is determined as a target channel matching the channel recommendation result.

In an exemplary embodiment, when the target channel is determined from the candidate channel set based on the similarities, it is ensured that the similarity between the target channel and the channel recommendation result is greater than a similarity threshold. For example, the similarity threshold is 80%.

Through step 3022, a matching target channel can be obtained for each channel recommendation result in the at least one channel recommendation result.

In one implementation, the process of obtaining at least one channel recommendation result based on the channel preference feature is cyclic process. One channel recommendation result is obtained in each cycle, and the channel recommendation result in the each cycle is associated with a previously obtained channel recommendation result. The channel recommendation result obtained in such a manner has a better effect. In this case, step 3021 and step 3022 are performed alternately, that is, each time one channel recommendation result is obtained, a target channel matching the channel recommendation result is obtained. In one implementation, an implementation process of obtaining at least one channel recommendation result based on the channel preference feature includes step 2-1 to step 2-3:

Step 2-1: Input the channel preference feature into a first target recommendation model, to obtain a channel recommendation result outputted by the first target recommendation model.

The first target recommendation model is a pre-trained model for outputting a channel recommendation result based on a channel preference feature. The first target recommendation model outputs one channel recommendation result based on the channel preference feature. In one implementation, the first target recommendation model includes a first target recommendation sub-model. The first target recommendation model outputs the channel recommendation result by using the first target recommendation sub-model. A structure of the first target recommendation sub-model is not limited in the embodiments of this application. For example, the first target recommendation sub-model is a fully-connected layer. A process of outputting the channel recommendation result by using the first target recommendation sub-model is implemented based on a formula 6:

$${a}_{1}^{l} = tanh ( {W}_{a}^{l} \cdot {s}_{1}^{l} + {b}_{a}^{l} ) \qquad ( formula 6 )$$

where a₁^{l} represents a channel recommendation result, where for example, a₁^{l} is a vector; tan h represents an activation function; Wₐ^{l} represents a weight of the first target recommendation sub-model; bₐ^{l} represents a bias of the first target recommendation sub-model; and s₁^{l} represents a channel preference feature.

Step 2-2: Obtain, in response to that a quantity of currently obtained channel recommendation results is less than a reference quantity, an updated channel preference feature based on the currently obtained channel recommendation result, and input the updated channel preference feature into the first target recommendation model, to obtain a new channel recommendation result outputted by the first target recommendation model.

The reference quantity is used for limiting a maximum quantity of channel recommendation results obtained based on the first target recommendation model. The reference quantity may be set according to experience or may be flexibly adjusted according to an application scenario, which is not limited in the embodiments of this application. For example, the reference quantity is set to 10. Because the target channels in the at least one target channel match the channel recommendation results one by one, a quantity of the target channels in the at least one target channel is the same as a quantity of the channel recommendation results, and the reference quantity is also used for limiting the quantity of the target channels in the at least one target channel.

Each time one channel recommendation result is obtained, whether a quantity of the currently obtained channel recommendation results reaches the reference quantity is determined. If a quantity of the currently obtained channel recommendation results is less than the reference quantity, an updated channel preference feature needs to be obtained based on the currently obtained channel recommendation result, to facilitate continuing to obtain a new channel recommendation result according to the updated channel preference feature.

In one implementation, a process of obtaining an updated channel preference feature based on the currently obtained channel recommendation result is: obtaining a target channel matching the currently obtained channel recommendation result from the candidate channel set; obtaining a target channel feature corresponding to the target channel, and obtaining an updated channel feature sequence after adding the target channel feature behind the last channel feature in an existing channel feature sequence; and processing the updated channel feature sequence to obtain the updated channel preference feature.

After the updated channel preference feature is obtained, the updated channel preference feature is inputted to the first target recommendation model, and a channel recommendation result outputted by the first target recommendation model is used as a new channel recommendation result.

Step 2-3: Repeat the steps until the quantity of the currently obtained channel recommendation results reaches the reference quantity.

The process of obtaining at least one channel recommendation result is a cyclic process. One channel recommendation result is obtained in each cycle according to the manner of step 2-2. Each time a new channel recommendation result is obtained, whether a quantity of the currently obtained channel recommendation results reaches the reference quantity is determined. If the quantity of the currently obtained channel recommendation result is less than the reference quantity, it is continued to obtain a next new channel recommendation result is obtained until the quantity of the currently obtained channel recommendation results reaches the reference quantity. When the quantity of the currently obtained channel recommendation results reaches the reference quantity, the currently obtained channel recommendation result is the at least one channel recommendation result that needs to be obtained.

As the quantity of the obtained channel recommendation results increases, a quantity of channel features in the channel feature sequence used for obtaining the updated channel preference feature also continuously increases. For example, for a process of obtaining the t^{th} channel recommendation result, the channel feature sequence is represented as Seqₜ^{l}={f₁^{l}, f₂^{l}, . . . , fₘ^{l}, fₘ₊₁^{l}, . . . , fₘ₊ₜ₋₁^{l}}, where Seqₜ^{l} represents a channel feature sequence required for obtaining the t^{th} (t is an integer greater than or equal to 1) channel recommendation result; m (m is an integer greater than or equal to 1) represents a quantity of historical pushed resources; (t−1) represents a quantity of channel recommendation results that has been obtained; and fₘ₊ₜ₋₁^{l} represents a channel feature obtained based on the (t−1)^{th} channel recommendation result, where the channel feature is located at the (m+t−1)^{th} arrangement position in the channel feature sequence.

In an exemplary embodiment, after at least one channel recommendation result is obtained, the channel recommendation results are arranged according to an obtaining order, to obtain a channel recommendation result sequence.

In a process of obtaining at least one channel recommendation result based on step 2-1 to step 2-3, each time one channel recommendation result is obtained, a target channel matching the channel recommendation result is obtained, and after all channel recommendation results are obtained, target channels respectively matching the channel recommendation results are obtained. That is, at least one target channel that performs channel constraining on at least one target resource that needs to be recommended to the target object is obtained. The process of obtaining a channel recommendation result based on step 2-1 to step 2-3 is merely an exemplary description when a reference quantity is greater than 2. When the reference quantity is 1, at least one channel recommendation result can be obtained based on step 2-1. When the reference quantity is 2, at least one channel recommendation result can be obtained based on step 2-1 and step 2-2.

After target channels respectively matching the channel recommendation results are obtained, the target channels respectively matching the channel recommendation results are used as at least one target channel. The at least one target channel is a channel corresponding to at least one target resource that finally needs to be pushed to the target object.

In one implementation, after the at least one target channel is obtained, a target channel sequence is obtained based on at least one target channel. For example, a manner of obtaining a target channel sequence based on the at least one target channel is: arranging, according to an arrangement order of the channel recommendation results in the channel recommendation result sequence, target channels respectively matching the channel recommendation results, to obtain the target channel sequence. After the target channel sequence is based on such a manner, a target channel located at a specific arrangement position in the target channel sequence matches a channel recommendation result located at a same arrangement position in the channel recommendation result sequence.

The content preference feature is used for representing a content reference of the target object. At least one target channel is used for constraining presentation forms of contents of resources that need to be pushed to the target object. The candidate resource set includes candidate resources that can be pushed. At least one target resource is obtained from the candidate resource set based on the content preference feature and the at least one target channel. The at least one target resource is a resource that needs to be pushed to the target object.

In one implementation, a process of obtaining the at least one target resource from the candidate resource set based on the content preference feature and the at least one target channel includes step 3031 and step 3032 as follows:

Step 3031: Obtain at least one content recommendation result based on the content preference feature.

There is at least one content recommendation results. Each content recommendation result is used for indicating a virtual content. A presentation form of the content recommendation result is not limited in the embodiments of this application. For example, the content recommendation result is represented by using one feature vector, and indicates one virtual content based on the feature vector. The virtual content herein is relative to real candidate contents corresponding to the candidate resources. The virtual content may be consistent with a specific candidate content, or may be consistent with none of the candidate contents. In one implementation, the at least one content recommendation result constitutes a content recommendation result sequence.

For example, one content recommendation result corresponds to one target channel. A quantity of channel recommendation results is the same as a quantity of content recommendation results. One target channel is obtained according to each channel recommendation result. The target channels obtained according to the channel recommendation results are arranged according to an obtaining order of the channel recommendation results, to obtain a target channel sequence. The content recommendation results are arranged according to an obtaining order, to obtain a content recommendation result sequence. If an arrangement position of one target channel in the target channel sequence is the same as an arrangement position of one content recommendation result in the content recommendation result sequence, the one target channel is used as one target channel corresponding to the one content recommendation result.

Step 3032: Use a resource in the candidate resource set matching the at least one content recommendation result and corresponding to the at least one target channel as the target resource.

The content recommendation result is used for indicating a virtual resource, while a candidate resource having a real candidate content is actually pushed to the target object. Therefore, after the content recommendation result is obtained, a target resource needs to be obtained from the candidate resource set with reference to the content recommendation result.

In one implementation, one content recommendation result corresponds to one target channel, and a process of implementing step 3032 is: obtaining, from a candidate resource set, a resource matching one content recommendation result and corresponding to a first target channel, and using, in the candidate resource set, the resource matching the one content recommendation result and corresponding to the first target channel resource as a target resource. The first target channel is a target channel corresponding to the one content recommendation result. At least one target resource is obtained according to such a manner.

A process of obtaining a target resource corresponding to the first target channel is used as an example for description. In one implementation, a process of obtaining, from a candidate resource set, a resource matching one content recommendation result and corresponding to a first target channel is obtaining, from the candidate resource set, a corresponding candidate channel as a candidate resource of the first target channel, and using a set of candidate resources using the corresponding candidate channel as the first target channel as a target candidate resource set; and obtaining, from the target candidate resource set, a resource matching the one content recommendation result, the resource being a resource matching the one content recommendation result and corresponding to the first target channel.

For example, the target candidate resource set are constituted by candidate resources satisfying a condition in the candidate resource set. The candidate resource satisfying a condition refers to a candidate resource of which a corresponding candidate channel is a specified channel (that is, the first target channel). The specified channel (that is, the first target channel) is a target channel of which an arrangement position in the target channel sequence is consistent with an arrangement position of the one content recommendation result in the content recommendation result sequence. That is, a target candidate resource set is determined according to a constraint of the target channel in the target channel sequence, so as to obtain, from the target candidate resource set, a target resource matching the one content recommendation result.

In an exemplary example, for the n^{th} content recommendation result in the content recommendation result sequence, the terminal determines the n^{th} target channel in the target channel sequence, further determines, in the candidate resource set, candidate resources of which corresponding candidate channels are the n^{th} target channel as a target candidate resource set (for example, when the n^{th} target channel is a short video channel, presentation forms of contents of the candidate resources in the target candidate resource set are all short videos), and then, obtains a corresponding target resource from the target candidate resource set based on the n^{th} content recommendation result and the n^{th} target channel.

In one implementation, a process of obtaining a resource matching the one content recommendation result from the target candidate resource set is: converting contents of candidate resources in the target candidate resource set into a presentation form the same as that of the one content recommendation result; respectively calculating similarities between contents of the candidate resources in the target candidate resource set and the one content recommendation result based on the presentation form after the conversion; and using a candidate resource with a highest content similarity in the target candidate resource set as a resource matching the one content recommendation result. Because presentation forms of the candidate resources in the target candidate resource set may be different from the presentation form of the content recommendation result, the presentation forms need to be converted first to facilitate similarity calculation. For example, when the presentation form of the content recommendation result is a feature vector, the contents of the candidate resources need to be converted into the presentation form of a feature vector. A manner of calculating a similarity between two vectors is not limited in the embodiments of this application. For example, a cosine similarity between two vectors is used as a similarity between the two vectors.

In one implementation, the process of obtaining at least one content recommendation result based on the content preference feature is cyclic process. One content recommendation result is obtained in each cycle, and the content recommendation result in the each cycle is associated with a previously obtained content recommendation result. The content recommendation result obtained in such a manner has a better effect. In this case, step 3031 and step 3032 are performed alternately, that is, each time one content recommendation result is obtained, a target resource matching the content recommendation result and corresponding to a target channel corresponding to the content recommendation result is obtained based on the content recommendation result. In one implementation, an implementation process of obtaining at least one content recommendation result based on the content preference feature includes step 3-1 to step 3-3:

Step 3-1: Input the content preference feature into a second target recommendation model, to obtain a content recommendation result outputted by the second target recommendation model.

The second target recommendation model is a pre-trained model for outputting a content recommendation result based on a content preference feature. The second target recommendation model outputs one content recommendation result based on the content preference feature. In one implementation, the second target recommendation model includes a second target recommendation sub-model. The second target recommendation model outputs the content recommendation result by using the second target recommendation sub-model. A structure of the second target recommendation sub-model is not limited in the embodiments of this application. For example, the second target recommendation sub-model is a fully-connected layer. When the first target recommendation sub-model and the second target recommendation sub-model have a same structure, because the first target recommendation sub-model and the second target recommendation sub-model are configured to recommend results in different aspects, parameters of the first target recommendation sub-model and the second target recommendation sub-model are different. In one implementation, a process of outputting the content recommendation result by using the second target recommendation sub-model is implemented based on a formula 7:

$${a}_{1}^{h} = tanh ( {W}_{a}^{h} \cdot {s}_{1}^{h} + {b}_{a}^{h} ) \qquad ( formula 7 )$$

where a₁^{h} represents a content recommendation result, where for example, a₁^{h} is a vector; tan h represents an activation function; Wₐ^{h} represents a weight of the second target recommendation sub-model; bₐ^{h} represents a bias of the second target recommendation sub-model; and s₁^{h} represents a content preference feature.

Step 3-2: Obtain, in response to that a quantity of currently obtained content recommendation results is less than the reference quantity, an updated content preference feature based on the currently obtained content recommendation result, and input the updated content preference feature into the second target recommendation model, to obtain a new content recommendation result outputted by the second target recommendation model.

The reference quantity is used for limiting a maximum quantity of content recommendation results obtained based on the second target recommendation model obtaining. The reference quantity is the same as the reference quantity used for limiting the maximum quantity of channel recommendation results obtained based on the first target recommendation model. Because the target resources in the at least one target resource match the content recommendation results one by one, a quantity of the target resources in the at least one target resource is the same as a quantity of the content recommendation results, and the reference quantity is also used for limiting the quantity of the target resources in the at least one target resource.

In one implementation, a process of obtaining an updated content preference feature based on the currently obtained content recommendation result is: obtaining a target content matching the content recommendation result from a candidate content set corresponding to the candidate resource set; obtaining a target content feature corresponding to the target content, and obtaining an updated content feature sequence after adding the target content feature behind the last content feature in an existing content feature sequence; and processing the updated content feature sequence to obtain the updated content preference feature.

After the updated content preference feature is obtained, the updated content preference feature is inputted to the second target recommendation model, and a content recommendation result outputted by the second target recommendation model is used as a new content recommendation result.

Step 3-3: Repeat the steps until the quantity of the currently obtained content recommendation results reaches the reference quantity.

The process of obtaining at least one content recommendation result is a cyclic process. One content recommendation result is obtained in each cycle according to the manner of step 3-2. Each time one content recommendation result is obtained, whether a quantity of the currently obtained content recommendation results reaches the reference quantity is determined. If the quantity of the currently obtained content recommendation result is less than the reference quantity, it is continued to obtain a next new content recommendation result is obtained until the quantity of the currently obtained content recommendation results reaches the reference quantity. When the quantity of the currently obtained content recommendation results reaches the reference quantity, the currently obtained content recommendation result is the at least one content recommendation result that needs to be obtained.

As the quantity of the obtained content recommendation results increases, a quantity of content features in the content feature sequence used for obtaining the updated content preference feature also continuously increases. For example, for a process of obtaining the t^{th} content recommendation result, the content feature sequence may be represented as Seqₜ^{h}={f₁^{h}, f₂^{h}, . . . , fₘ^{h}, fₘ₊₁^{h}, . . . , fₘ₊ₜ₋₁^{h}}, where Seqₜ^{h} represents a content feature sequence required for obtaining the t^{th} (t is an integer greater than or equal to 1) content recommendation result; m (m is an integer greater than or equal to 1) represents a quantity of historical pushed resources; (t−1) represents a quantity of content recommendation results that has been obtained; and fₘ₊ₜ₋₁^{h} represents a content feature obtained based on the (t−1)^{th} content recommendation result, where the content feature is located at the (m+t−1)^{th} arrangement position in the content feature sequence.

In an exemplary embodiment, after at least one content recommendation result is obtained, the content recommendation results are arranged according to an obtaining order, to obtain a content recommendation result sequence.

In a process of obtaining at least one content recommendation result based on step 3-1 to step 3-3, each time one content recommendation result is obtained, a target resource corresponding to one target channel is obtained based on the content recommendation result, and after all content recommendation results are obtained, target resources respectively corresponding to the target channels are obtained. That is, at least one target resource that needs to be pushed to the target object is obtained. The process of obtaining at least one content recommendation result based on step 3-1 to step 3-3 is merely an exemplary description when a reference quantity is greater than 2. When the reference quantity is 1, at least one content recommendation result can be obtained based on step 3-1. When the reference quantity is 2, at least one content recommendation result can be obtained based on step 3-1 and step 3-2.

At least one target resource is obtained based on the content preference feature and the target channels. The at least one target resource is used as a resource that finally needs to be pushed to the target object.

In one implementation, after the at least one target resource is obtained, a target resource sequence is obtained based on at least one target resource. For example, a manner of obtaining a target resource sequence based on the at least one target resource is: arranging, according to an arrangement order of the content recommendation results in the content recommendation result sequence, target resources obtained based on the content recommendation results, to obtain the target resource sequence. After the target resource sequence is based on such a manner, a target resource located at a specific arrangement position in the target resource sequence matches a content recommendation result located at a same arrangement position in the content recommendation result sequence.

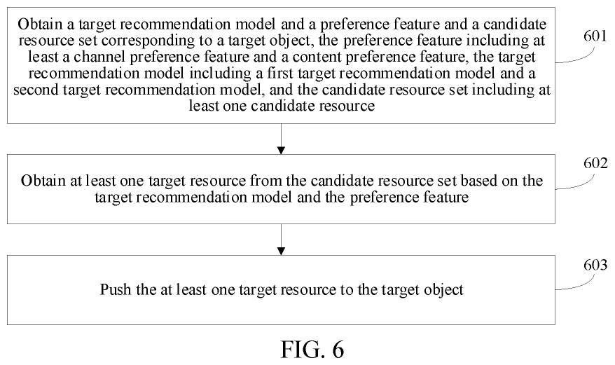

Before the first target recommendation model and the second target recommendation model are used for implementing a resource pushing task, a target recommendation model including the first target recommendation model and the second target recommendation model needs to be trained first. For details of a process of training the target recommendation model, reference may be made to the embodiment shown in FIG. 6, and details are not described herein again.

In another possible implementation, an implementation of obtaining at least one target resource from the candidate resource set based on the preference feature is: obtaining at least one target content from a candidate content set based on the content preference feature, one candidate resource corresponding to one candidate content, and the candidate content set including candidate contents corresponding to candidate resources in the candidate resource set; and obtaining the at least one target resource from the candidate resource set based on the channel preference feature and the at least one target content. In such an implementation, a target content is first obtained under the constraint of a content preference feature, and then, a target resource is obtained under the constraint of both the target content and the channel preference feature.

In one implementation, an implementation of obtaining at least one target content from the candidate content set based on the content preference feature is: obtaining at least one content recommendation result based on the content preference feature; and using a content in the candidate content set matching at least one content recommendation result as a target content. An implementation principle of this process is similar to the implementation principle in step 3021 and step 3022, and details are not described herein again.

In one implementation, an implementation of obtaining at least one target resource from the candidate resource set based on the channel preference feature and at least one target content is: obtaining at least one channel recommendation result based on the channel preference feature; and using a resource in the candidate resource set matching the at least one channel recommendation result and corresponding to the at least one target content as the target resource. An implementation principle of this process is similar to the implementation principle in step 3031 and step 3032, and details are not described herein again.

Step 303: Push the at least one target resource to the target object.

After the at least one target resource is obtained, the at least one target resource is pushed to the target object for the target object to browse or view. In one implementation, a manner of pushing the at least one target resource to the target object is: pushing the at least one target resource to the target object based on a pushed-resource obtaining request of the target object. A manner of obtaining the pushed-resource obtaining request is not limited in the embodiments of this application. For example, the pushed-resource obtaining request may be obtained based on a slide-down gesture of the target object or be automatically obtained based on a successful login instruction of the target object or the like.

In one implementation, when after the at least one target resource is obtained, the at least one target resource is sequentially arranged to obtain a target resource sequence, the target resource sequence is pushed to the target object. For example, a process of pushing the target resource sequence to the target object is: performing page layout for target resources according to an arrangement order in the target resource sequence, to obtain a pushed page, and displaying the pushed page on the terminal screen. A page layout rule is not limited in the embodiments of this application provided that a target resource located in the front of the target resource sequence is still in the front of the page after the layout. In addition, a size of the pushed page may be greater than a visible region of the screen. In this case, a process of displaying the pushed page on the terminal screen is: displaying a target region of the pushed page in the visible region of the screen, and display another region of the pushed page according to a slide instruction of the target object. The target region of the pushed page may refer to an upper region of the pushed page, or may refer to an upper-left region of the pushed page or the like, which is not limited in the embodiments of this application.

For example, the process of displaying the pushed page on the terminal screen is shown in FIG. 4. In a resource library 41, each channel corresponds to millions of resources. After preliminary sifting and matching and sorting are performed based on the historical behavior information of the target object, hundreds of resources are selected from millions of resources corresponding to each channel as candidate resources, and a set of the candidate resources is used as a candidate resource set. The candidate resource set includes heterogeneous resources corresponding to different channels. In a pushing module 42, a target recommendation model 43 constituted by the first target recommendation model and the second target recommendation model is invoked to implement joint pushing of the heterogeneous resources, to obtain a target resource sequence 44. Page layout is performed for target resources according to an arrangement order in the target resource sequence, to obtain a pushed page, and a target region in the pushed page is displayed on the terminal screen for the target object to browse or view. The display page on the terminal screen is shown as 400.

After the at least one target resource is pushed to the target object, feedback from the target object can be collected, for example, click/tap situations and reading durations of the target object on target resources in the at least one target resource, to facilitate subsequently further adjusting the recommendation model according to the feedback from the target object, thereby further improving the recommendation effect of the model.

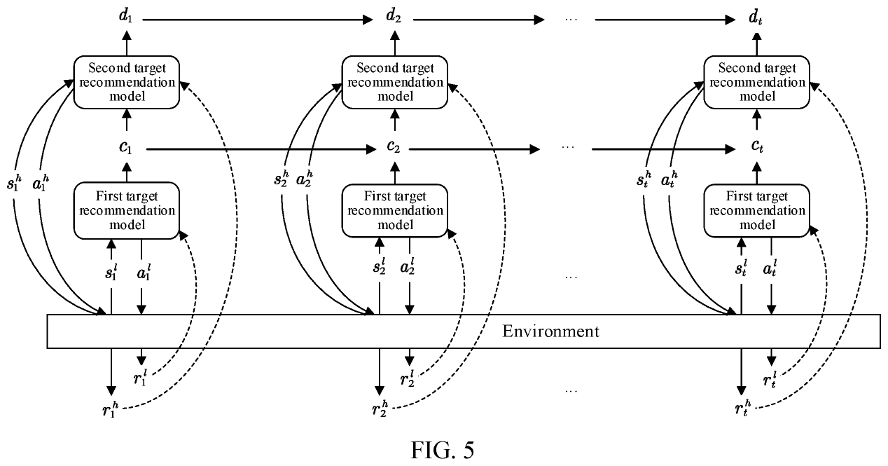

For example, a process of obtaining a target resource sequence is shown in FIG. 5 In FIG. 5, target resources (d₁, d₂, . . . dₜ) located at arrangement positions in the target resource sequence are obtained one by one. In a process of obtaining a target resource dₜ located at the t^{th} position in the target resource sequence, a channel preference feature sₜ^{l} and a content preference feature sₜ^{h} are obtained first, the channel preference feature sₜ^{l} is inputted into a first target recommendation model, to obtain a channel recommendation result aₜ^{l} located at the t^{th} position outputted by the first target recommendation model, and further, a target channel cₜ^{l} matching the channel recommendation result aₜ^{l} is obtained from the candidate channel set. The content preference feature sₜ^{h} is inputted into a second target recommendation model, to obtain a content recommendation result located at the t^{th} position outputted by the second target recommendation model, and further, a target resource dₜ corresponding to the target channel cₜ^{l} is obtained from the candidate resource set based on the constraint of the target channel cₜ^{l}.

After the obtained target resource sequence is pushed to the target object, the pushing system (environment) may collect feedback from the target object on the target resources, and generate feedback information corresponding to target channels and target resources according to the feedback from the target object on the target resources. The feedback information is used for subsequently adjusting the first target recommendation model and the second target recommendation model. For example, feedback information rₜ^{l} corresponding to the target channel located at the t^{th} position and feedback information rₜ^{h} corresponding to the target resource located at the t^{th} position are generated according to feedback from the target object on the target resource located at the t^{th} position, and the feedback information is fed back to the first target recommendation model and the second target recommendation model for subsequent updating of the recommendation models.

In the embodiments of this application, at least one target resource is obtained and pushed to a target object based on a preference feature including a channel preference feature and a content preference feature. In such a resource pushing process, the channel preference feature reflects channel information, and the content preference feature reflects content information. The resource pushing process integrates preferences of the target object in different dimensions, so that the target resource pushed to the target object not only conforms to channel preferences of the target object, but also conforms to content references of the target object, which is beneficial to improving the resource pushing effect, and further increasing the CTRs of the pushed resources.

Based on the implementation environment shown in FIG. 2, the embodiments of this application provide a resource pushing method, performed by a computer device. The computer device may be the terminal 21 or the server 22. In the embodiments of this application, descriptions are provided by using an example in which the resource pushing method is applied to the terminal 21. As shown in FIG. 6, the resource pushing method provided in this embodiment of this application includes step 601 to step 603:

Step 601: Obtain a target recommendation model and a preference feature and a candidate resource set corresponding to a target object, the preference feature including at least a channel preference feature and a content preference feature, the target recommendation model including a first target recommendation model and a second target recommendation model, and the candidate resource set including at least one candidate resource.

The target recommendation model refers to a trained model used for implementing resource pushing. The target recommendation model may be trained by the terminal or may be trained by the server, which is not limited in the embodiments of this application. When the target recommendation model may be trained by the terminal, the terminal can directly obtain the target recommendation model. When the target recommendation model may be trained by the server, the terminal can obtain the target recommendation model from the server. An example in which the target recommendation model is trained by the terminal is used for description in the embodiments of this application.

For a manner of obtaining a preference feature corresponding to the target object and a candidate resource set, reference may be made to step 301, and details are not described herein again.

Before the target recommendation model is obtained, the target recommendation model needs to be trained first. In one implementation, a process of training the target recommendation model includes step 6011 and step 6012 as follows:

Step 6011: Obtain a training sample set, the training sample set including at least one training sample, the training sample including a sample channel feature, a sample content feature, and feedback information corresponding to at least one sample pushed-resource.

The training sample is obtained based on historical pushed resources of a plurality of interaction objects. For each interaction object, in a resource pushing scenario, the interaction object transmits one or more resource pushing requests in an application program or a web page capable of pushing resources, and the pushing system pushes a resource sequence for each resource pushing request. The each resource sequence includes one or more historical pushed resource. Forms all resource sequences pushed for one or more resource pushing requests of an interaction object constitute a session. A manner in which the interaction object transmits a resource pushing request is not limited in the embodiments of this application. For example, the interaction object transmits the resource pushing request through a slide-down gesture on the screen. In this embodiment of this application, training samples are obtained based on historically actually pushed resources sequences. A quantity of interaction objects, a quantity of sessions of the interaction objects, a quantity of pushing instances extracted from the sessions, and a quantity of clicks/taps involved in the pushing instances that are involved during obtaining of training samples are not limited in the embodiments of this application. For example, the quantity of interaction objects is 22.5 million, the quantity of sessions of the interaction objects is 141 million, the quantity of pushing instances extracted from the sessions is 3.8 billion, and 355 million clicks/taps are involved in the 3.8 billion pushing instances.

Each training sample includes a sample channel feature, a sample content feature, and feedback information corresponding to at least one sample pushed-resource. For a process of obtaining a sample channel feature and a sample content feature in each training sample, reference may be made to the process of obtaining a channel preference feature and a content preference feature corresponding to a target object in step 301, and details are not described herein again. At least one sample pushed-resource in each training sample refers to an actually pushed resource based on a sample channel feature and a sample content feature in the training sample. Feedback information corresponding to the at least one sample pushed-resource includes, but is not limited to, actual operation information of a specific interaction object on each sample pushed-resource in the pushed at least one sample pushed-resource after the at least one sample pushed-resource is pushed to the interaction object, and pushing characteristic information and the like of the sample pushed-resource. The operation performed by the interaction object on each sample pushed-resource includes, but is not limited to, a click/tap operation, a reading operation, and the like.

Step 6012: Train an initial recommendation model based on the sample channel feature, the sample content feature, and the feedback information in the training sample, to obtain the target recommendation model, the initial recommendation model including a first initial recommendation model and a second initial recommendation model.

After the training sample set is obtained, the initial recommendation model is trained by using training samples in the training sample set to obtain the target recommendation model. In one implementation, in a process of training the target recommendation model, model parameters are updated by using the logic of a reinforcement learning algorithm. A specific reinforcement learning algorithm of which the logic is adopted is not limited in the embodiments of this application. For example, the logic of the Deep Deterministic Policy Gradient (DDPG) algorithm, the logic of the Deep Q-Learning Network (DQN) algorithm, the logic of the Asynchronous Advantage Actor-Critic (A3C) algorithm, and the like are adopted.

For example, the first initial recommendation model includes a first initial recommendation sub-model and a first initial evaluation sub-model, and the second initial recommendation model includes a second initial pushing sub-model and a second initial evaluation sub-model. For example, a process of training the initial recommendation model is a process of updating model parameters of the first initial recommendation sub-model, the first initial evaluation sub-model, the second initial pushing sub-model, and the second initial evaluation sub-model.

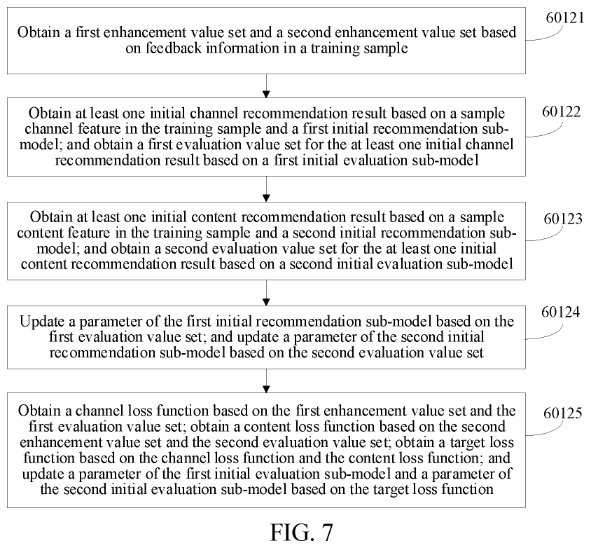

In one implementation, the first target recommendation model is configured to a channel recommendation result based on the channel preference feature, and the second target recommendation model is configured to output a content recommendation result based on the content preference feature. Referring to FIG. 7, a method of training an initial recommendation model based on a sample channel feature, a sample content feature, and feedback information in a training sample includes step 60121 to step 60125 as follows:

Step 60121: Obtain a first enhancement value set and a second enhancement value set based on the feedback information in the training sample.

The training sample herein refers to a training sample required for training the initial recommendation model once. There may be one or more training samples, which is not limited in the embodiments of this application. When there are a plurality of training samples, relevant data obtained in all of step 60121 to step 60123 is respectively obtained for each training sample. In this embodiment of this application, in all of step 60121 to step 60123, an example in which one training sample is required for training the initial recommendation model once is used to describe a process of obtaining relevant data.

The first enhancement value set refers to a set of first enhancement values. The first enhancement value refers to a channel enhancement value. The first enhancement value set is used for guiding the update of the first initial recommendation model. The second enhancement value set refers to a set of second enhancement values. The second enhancement value refers to a content enhancement value. The second enhancement value set is used for guiding the update of the second initial recommendation model.

In one implementation, a process of obtaining a first enhancement value set and a second enhancement value set based on the feedback information in the training sample includes step A to step D as follows:

Step A: Obtain at least one of reading duration information, diversity information, or novelty information of the sample pushed-resource and click/tap information of the sample pushed-resource based on the feedback information in the training sample.

The sample pushed-resource involved in step A to step C refers to any one of the at least one sample pushed-resource.

The feedback information includes, after at least one sample pushed-resource is pushed to an interaction object, click/tap situations of the interaction object on the sample pushed-resources. Click/tap information of each sample pushed-resource in at least one sample pushed-resource can be obtained according to the click/tap situations. The click/tap information is used for indicating whether a sample pushed-resource is clicked/tapped.

In some embodiments, in addition to the click/tap situations of the interaction object on the sample pushed-resources, the feedback information further includes reading situations of the interaction object on the sample pushed-resources. Reading duration information of each sample pushed-resource in at least one sample pushed-resource can be obtained according to the reading situations. The reading duration information is used for indicating a duration during which a sample pushed-resource is read. Reading a resource in the embodiments of this application may refer to either browsing a content presented in the form of an article, may refer to viewing a content presented in the form of a video, or may refer to listening to a content presented in the form of audio or the like.

For example, sample pushed-resources in the at least one sample pushed-resource have an arrangement order, and the sample pushed-resources in the at least one sample pushed-resource are sequentially arranged according to the arrangement order, to obtain a sample pushed-resource sequence.

The diversity information is used for evaluating the diversity of the sample pushed-resource, and the novelty information is used for evaluating the novelty of the sample pushed-resource. In one implementation, in addition to the click/tap situations of the interaction object on the sample pushed-resources, the feedback information further includes information about content tags corresponding to the sample pushed-resources in the at least one sample pushed-resource. The information about the content tags is used for representing which content tags are involved in the content of the sample pushed-resource.

For example, for one sample pushed-resource in the at least one sample pushed-resource, a manner of obtaining diversity information of the sample pushed-resource is: collecting statistics on content tags corresponding to sample pushed-resources having arrangement positions located before the sample pushed-resource in the sample pushed-resource sequence, comparing content tags corresponding to the sample pushed-resource with the previous content tags, calculating an increment of repeated content tags in the content tags corresponding to the sample pushed-resource, and using the increment of the repeated content tags as the diversity information of the sample pushed-resource. The previous content tags refer to content tags corresponding to sample pushed-resources having arrangement positions located before the one sample pushed-resource in the sample pushed-resource sequence. For example, the increment of repeated content tags refers to a quantity of repeated content tags, or refers to a ratio of the quantity of repeated content tags to a total quantity of the previous content tags or the like.

In one implementation, in addition to the click/tap situations of the interaction object on the sample pushed-resources, the feedback information further includes a user interest tag. For one sample pushed-resource in the at least one sample pushed-resource, a manner of obtaining novelty information of the sample pushed-resource is: comparing content tags corresponding to the sample pushed-resource with the user interest tag, calculating an increment of new content tags in the content tags corresponding to the sample pushed-resource, and using the increment of the new content tag as the novelty information of the one sample pushed-resource. For example, the new content tag refers to a content tag that does not belong to the user interest tags in the content tags corresponding to the sample pushed-resource. For example, the increment of the new content tags refers to a quantity of the new content tags, or refers to a ratio of the quantity of the new content tags to a total quantity of the user interest tags or the like.

After at least one of reading duration information, diversity information, or novelty information of the sample pushed-resource and click/tap information of the sample pushed-resource are obtained, step B and step C are performed.

Step B: Obtain a first enhancement value corresponding to the sample pushed-resource based on the click/tap information of the sample pushed-resource.

The first enhancement value refers to a channel enhancement value. The click/tap information of a sample pushed-resource can be considered as click/tap information of a channel corresponding to the sample pushed-resource. Further, the first enhancement value in the channel aspect corresponding to the sample pushed-resource can be obtained according to the click/tap information of the sample pushed-resource.

In one implementation, a process of obtaining a first enhancement value corresponding to the sample pushed-resource based on the click/tap information of the sample pushed-resource is: searching for a score corresponding to the click/tap information of the sample pushed-resource, and using the score corresponding to the sample pushed-resource as the first enhancement value corresponding to the sample pushed-resource. For example, a correspondence between the click/tap information and the score is preset and stored. The score corresponding to the click/tap information of the sample pushed-resource is directly based on the correspondence between the click/tap information and the score, to further obtain the first enhancement value corresponding to the sample pushed-resource.

For example, in the correspondence between the click/tap information and the score, a score corresponding to click/tap information used to indicate being clicked/tapped is 1, and a score corresponding to click/tap information used to indicate being not clicked/tapped is 0. In this case, when the click/tap information of the one sample pushed-resource indicates that the one sample pushed-resource is clicked/tapped, a first enhancement value corresponding to the one sample pushed-resource is 1, and when the click/tap information of the one sample pushed-resource indicates that the one sample pushed-resource is not clicked/tapped, a first enhancement value corresponding to the sample pushed-resource is 0.

Step C: Obtain a second enhancement value corresponding to the sample pushed-resource based on the at least one of the reading duration information, the diversity information, or the novelty information of the sample pushed-resource and the click/tap information of the sample pushed-resource.

A second enhancement value corresponding to the sample pushed-resource is obtained based on all the information of the sample pushed-resource obtained in step A. The second enhancement value refers to a content enhancement value.

In one implementation, all the information of the sample pushed-resource obtained in step A includes click/tap information, reading duration information, diversity information, and novelty information of the sample pushed-resource. In this case, the process of obtaining a second enhancement value corresponding to the sample pushed-resource is obtaining the second enhancement value set corresponding to the sample pushed-resource based on the click/tap information, the reading duration information, the diversity information, and the novelty information of the sample pushed-resource.

In one implementation, a process of obtaining the second enhancement value set corresponding to the sample pushed-resource based on the click/tap information, the reading duration information, the diversity information, and the novelty information of the sample pushed-resource is: converting the click/tap information of the sample pushed-resource into a click/tap enhancement value corresponding to the sample pushed-resource; converting the reading duration information of the sample pushed-resource into a reading enhancement value corresponding to the sample pushed-resource; converting the diversity information of the sample pushed-resource into a diversity enhancement value corresponding to the sample pushed-resource; converting the novelty information of the sample pushed-resource into a novelty enhancement value corresponding to the sample pushed-resource; and determining the second enhancement value corresponding to the sample pushed-resource based on the click/tap enhancement value, the reading enhancement value, the diversity enhancement value, and the novelty enhancement value.

The click/tap enhancement value is used for optimizing a CTR of a resource pushed based on a model. The reading enhancement value is used for learning an actual reading preference of an interaction object. The diversity enhancement value is used for measuring the diversity. The novelty enhancement value is used for measuring the novelty. The diversity enhancement value and novelty enhancement value are beneficial to improving the long-term experience of the interaction object.

For example, a manner of converting information into an enhancement value is: searching for a score corresponding to information in a correspondence between the score and the information, and using the score corresponding to the information as an enhancement value.

In one implementation, a process of determining the second enhancement value corresponding to the sample pushed-resource based on the click/tap enhancement value, the reading enhancement value, the diversity enhancement value, and the novelty enhancement value is implemented based on a formula 8:

$${r}_{t}^{h} = {\sum }_{i = 1}^{4} {( {r}_{i}^{t} + {b}_{i}^{r} )}^{{λ}_{i}^{{c}_{t}}} \qquad ( formula 8 )$$

where rₜ^{h} represents a second enhancement value corresponding to a sample pushed-resource located at the t^{th} position in the sample pushed-resource sequence, rᵢ^{t} represents the i^{th} (i is an integer greater than or equal to 1 and less than or equal to 4) enhancement value in a click/tap enhancement value, a reading enhancement value, a diversity enhancement value, and a novelty enhancement value, bᵢ^{r} represents a bias of the i^{th} (i is an integer greater than or equal to 1 and less than or equal to 4) enhancement value, and λᵢ^{c}^{ₜ} represents a weight of the i^{th} (i is an integer greater than or equal to 1 and less than or equal to 4) enhancement value. c^{t} represents a channel corresponding to the sample pushed-resource located at the t^{th} position. That is, the weight of the i^{th} (i is an integer greater than or equal to 1 and less than or equal to 4) enhancement value is set based on the channel corresponding to the sample pushed-resource. For example, a set of rᵢ^{t} is represented as r^{t}={r₁^{t}, r₂^{t}, r₃^{t}, r₄^{t}}={rₜ^{click}, rₜ^{time}, rₜ^{diver}, rₜ^{novel}}, where rₜ^{click} represents a click/tap enhancement value; rₜ^{time} represents a reading enhancement value; rₜ^{diver} represents a diversity enhancement value; and rₜ^{novel} represents a novelty enhancement value.

According to the manners in step A to step C above, first enhancement values respectively corresponding to sample pushed-resources in the at least one sample pushed-resource and second enhancement value respectively corresponding to sample pushed-resources can be obtained, and then, step D is performed.

Step D: Use a set of first enhancement values respectively corresponding to sample pushed-resources as the first enhancement value set, and use a set of second enhancement value respectively corresponding to the sample pushed-resources as the second enhancement value set.

After the first enhancement values respectively corresponding to the sample pushed-resources are obtained, a set of the first enhancement values respectively corresponding to the sample pushed-resources is used as the first enhancement value set. Therefore, the first enhancement value set is obtained. After the second enhancement values respectively corresponding to the sample pushed-resources are obtained, a set of the second enhancement values respectively corresponding to the sample pushed-resources is used as the second enhancement value set. Therefore, the second enhancement value set is obtained.

Step 60122: Obtain at least one initial channel recommendation result based on the sample channel feature in the training sample and the first initial recommendation sub-model; and obtain a first evaluation value set for the at least one initial channel recommendation result based on the first initial evaluation sub-model.

The first initial recommendation model includes a first initial recommendation sub-model and a first initial evaluation sub-model. The first initial recommendation sub-model is configured to output an initial channel recommendation result based on the sample channel feature. The first initial evaluation sub-model is configured to evaluate the initial channel recommendation result outputted by the first initial recommendation sub-model, and output a first evaluation value for the initial channel recommendation result.

For a process of obtaining at least one initial channel recommendation result based on the sample channel feature in the training sample and the first initial recommendation sub-model, reference may be made to the embodiment shown in FIG. 3, and details are not described herein again. Each one initial channel recommendation result is obtained, the one initial channel recommendation result is inputted into the first initial evaluation sub-model, to obtain a first evaluation value outputted by the first initial evaluation sub-model for the one initial channel recommendation result. There is at least one initial channel recommendation result. One first evaluation value is obtained for each initial channel recommendation result. A set of first evaluation values obtained for initial channel recommendation results is used as the first evaluation value set. For example, when a first evaluation value obtained for a specific initial channel recommendation result is used as the first evaluation value corresponding to the initial channel recommendation result, the first evaluation value set is a set of first evaluation values respectively corresponding to the initial channel recommendation results. The first evaluation value set is used for guiding the parameter update of the first initial recommendation model.

In one implementation, a model structure of the first initial recommendation model is an Actor-Critic structure. Based on this, in the first initial recommendation model, the first initial recommendation sub-model is an Actor model, and the first initial evaluation sub-model is a Critic model. For example, the first initial evaluation sub-model is a fully-connected layer.

A calculation formula of a first theoretical evaluation value used for evaluating the initial channel recommendation result is shown in a formula 9. In an actual Critic model, a formula 10 is used to predict the first theoretical evaluation value. The first evaluation values involved in the embodiments of this application all refers to first evaluation values predicted by the first initial evaluation sub-model.

$${Q}^{l} ( {s}_{t}^{l} , {a}_{t}^{l} ) = {E}_{{s}_{t + 1}^{l} , {r}_{t}^{l} ▯ E} [ {r}_{t}^{l} + γ {Q}^{l} ( {s}_{t + 1}^{l} , {a}_{t + 1}^{l} ) ] \qquad ( formula 9 )$$

$${q}^{l} ( {s}_{t}^{l} , {a}_{t}^{l} ) = ReLU ( {w}_{c 1}^{l \cdot } \cdot {s}_{t}^{l} + {w}_{c 2}^{l \cdot } \cdot {a}_{t}^{l} + {b}_{c}^{l} ) \qquad ( formula 10 )$$

where Q^{l}(sₜ^{l},aₜ^{l}) represents a first theoretical evaluation value used for evaluating the t^{th} initial channel recommendation result; rₜ^{l} represents a first enhancement value corresponding to the t^{th} sample pushed-resource in the sample pushed-resource sequence; γ represents a discount factor; Q^{l}(sₜ₊₁^{l},aₜ₊₁^{l}) represents a first theoretical evaluation value used for evaluating the (t+1)^{th} initial channel recommendation result; sₜ^{l} represents a channel feature corresponding to the t^{th} initial channel recommendation result; and aₜ^{l} represents the t^{th} initial channel recommendation result. q^{l}(sₜ^{l},aₜ^{l}) represents a first evaluation value corresponding to the t^{th} initial channel recommendation result outputted by the first initial evaluation sub-model; ReLU represents a rectified linear unit; and w_{c1}^{l} and w_{c2}^{l} represent weights of the first initial evaluation sub-model, and b_{c}^{l} represents a bias of the first initial evaluation sub-model. sₜ^{l} and aₜ^{l} are inputted in to the first initial evaluation sub-model, so that a first evaluation value corresponding to the t^{th} initial channel recommendation result outputted by the first initial evaluation sub-model can be obtained.

After first evaluation values respectively corresponding to the initial channel recommendation results are obtained, a set of the first evaluation values respectively corresponding to the initial channel recommendation results is used as a first evaluation value set.

Step 60123: Obtain at least one initial content recommendation result based on the sample content feature in the training sample and the second initial recommendation sub-model; and obtain a second evaluation value set for the at least one initial content recommendation result based on the second initial evaluation sub-model;

The second initial recommendation model includes a second initial recommendation sub-model and a second initial evaluation sub-model. The second initial recommendation sub-model is configured to output an initial content recommendation result based on the sample content feature. The second initial evaluation sub-model is configured to evaluate the initial content recommendation result outputted by the second initial recommendation sub-model, and output a second evaluation value for the initial content recommendation result. For a process of obtaining at least one initial content recommendation result based on the sample content feature in the training sample and the second initial recommendation sub-model, reference may be made to the embodiment shown in FIG. 3, and details are not described herein again. Each one initial content recommendation result is obtained, the one initial content recommendation result is inputted into the second initial evaluation sub-model, to obtain a second evaluation value outputted by the second initial evaluation sub-model for the one initial content recommendation result. There is at least one initial content recommendation result. One second evaluation value is obtained for each initial content recommendation result. A set of second evaluation values obtained for initial content recommendation results is used as the second evaluation value set. For example, when a second evaluation value obtained for a specific initial content recommendation result is used as the second evaluation value corresponding to the initial content recommendation result, the second evaluation value set is a set of second evaluation values respectively corresponding to the initial content recommendation results. The second evaluation value set is used for guiding the parameter update of the second initial recommendation model.

In one implementation, a model structure of the second initial recommendation model is an Actor-Critic structure. Based on this, in the second initial recommendation model, the second initial recommendation sub-model is an Actor model, and the second initial evaluation sub-model is a Critic model. For example, the second initial evaluation sub-model is a fully-connected layer.

A calculation formula of a second theoretical evaluation value used for evaluating the initial content recommendation result is shown in a formula 11. In an actual Critic model, a formula 12 is used to predict the second theoretical evaluation value. The second evaluation values involved in the embodiments of this application all refers to second evaluation values predicted by the second initial evaluation sub-model.

$${Q}^{h} ( {s}_{t}^{h} , {a}_{t}^{h} ) = {E}_{{s}_{t + 1}^{h} , {r}_{t}^{h} ▯ E} [ {r}_{t}^{h} + γ {Q}^{h} ( {s}_{t + 1}^{h} , {a}_{t + 1}^{h} ) ] \qquad ( formula 11 )$$

$${q}^{h} ( {s}_{t}^{h} , {a}_{t}^{h} ) = ReLU ( {w}_{c 1}^{h \cdot } \cdot {s}_{t}^{h} + {w}_{c 2}^{h \cdot } \cdot {a}_{t}^{h} + {b}_{c}^{h} ) \qquad ( formula 12 )$$

where Q^{h}(sₜ^{h},aₜ^{h}) represents a second theoretical evaluation value used for evaluating the t^{th} initial content recommendation result; rₜ^{h} represents a second enhancement value corresponding to the t^{th} sample pushed-resource in the sample pushed-resource sequence; γ represents a discount factor; Q^{h}(sₜ₊₁^{h},aₜ₊₁^{h}) represents a second theoretical evaluation value used for evaluating the (t+1)^{th} initial content recommendation result; sₜ^{h} represents a content feature corresponding to the t^{th} initial content recommendation result; and aₜ^{h} represents the t^{th} initial content recommendation result. q^{h}(sₜ^{h},aₜ^{h}) represents a second evaluation value corresponding to the t^{th} initial content recommendation result outputted by the second initial evaluation sub-model; ReLU represents a rectified linear unit; and w_{c1}^{h} and w_{c2}^{h} represent weights of the second initial evaluation sub-model, and b_{c}^{h} represents a bias of the second initial evaluation sub-model. sₜ^{h} and aₜ^{h} are inputted in to the second initial evaluation sub-model, so that a second evaluation value corresponding to the t^{th} initial content recommendation result outputted by the second initial evaluation sub-model can be obtained.

After second evaluation values respectively corresponding to the initial content recommendation results are obtained, a set of the second evaluation values respectively corresponding to the initial content recommendation results is used as a second evaluation value set.

Step 60124: Update a parameter of the first initial recommendation sub-model based on the first evaluation value set; and update a parameter of the second initial recommendation sub-model based on the second evaluation value set.

Each training sample corresponds to one first evaluation value set. That is, a quantity of first evaluation value sets is the same as a quantity of training samples used for training the initial recommendation model once. When a plurality of training samples are used for training the initial recommendation model once, in step 60124, a parameter of the first initial recommendation sub-model is updated based on a plurality of first evaluation value sets corresponding to the training samples, and a parameter of the second initial recommendation sub-model is updated based on a plurality of second evaluation value sets corresponding to the training samples. In this embodiment of this application, an example in which one training sample is used for training the initial recommendation model once is used for description.

In one implementation, a process of updating a parameter of the first initial recommendation sub-model based on the first evaluation value set is: calculating a first update gradient based on first evaluation values in the first evaluation value set; and updating the parameter of the first initial recommendation sub-model according to a direction of maximizing the first update gradient. In one implementation, a process of calculating a first update gradient based on first evaluation values in the first evaluation value set is: calculating a first target evaluation value based on the first evaluation values in the first evaluation value set; and calculating the first update gradient based on the first target evaluation value.

In one implementation, a manner of calculating a first target evaluation value based on the first evaluation values in the first evaluation value set is: respectively setting weights for the first evaluation values, and using a weighted average of the first evaluation values as the first target evaluation value. For example, a process of calculating the first update gradient based on the first target evaluation value is performed according to a formula 13:

$${∇}_{{ϕ}^{l}} J ( {π}_{{ϕ}^{l}} ) = {E}_{{a}^{l} ∈ {π}_{{ϕ}^{l}}} [ {∇}_{{ϕ}^{l}} log {π}_{{ϕ}^{l}} ( {s}^{l} , {a}^{l} ) {Q}_{{π}_{{ϕ}^{l}}}^{l} ( {s}^{l} , {a}^{l} ) ] \qquad ( formula 13 )$$

∇_{ϕ}_{^{l}}J(π_{ϕ}_{^{l}}) represents a first update gradient; π_{ϕ}_{^{l}} represents a random policy adopted when the first initial recommendation sub-model outputs a channel recommendation result; ϕ^{l} represents a parameter of the first initial recommendation sub-model; s^{l} represents a set of sample channel features involved in a process of outputting an initial channel recommendation result; a^{l} represents the initial channel recommendation result; and [symbol] (s^{l},a^{l}) represents a first target evaluation value.

After the first update gradient is obtained, because an optimization direction is that the greater the evaluation value, the better, the parameter of the first initial recommendation sub-model is updated according to a direction of maximizing the first update gradient. When a plurality of training samples are used for training the initial recommendation model once, the first update gradient refers to an average of a plurality of first update gradients calculated based on a plurality of first evaluation value sets corresponding to the training samples.

In one implementation, a process of updating a parameter of the second initial recommendation sub-model based on the second evaluation value set is: calculating a second update gradient based on second evaluation values in the second evaluation value set; and updating the parameter of the second initial recommendation sub-model according to a direction of maximizing the second update gradient.

In one implementation, a process of calculating a second update gradient based on second evaluation values in the second evaluation value set is: calculating a second target evaluation value based on the second evaluation values in the second evaluation value set; and calculating the second update gradient based on the second target evaluation value.

In one implementation, a manner of calculating a second target evaluation value based on the second evaluation values in the second evaluation value set is: respectively setting weights for the second evaluation values, and using a weighted average of the second evaluation values as the second target evaluation value. For example, a process of calculating the second update gradient based on the second target evaluation value is performed according to a formula 14:

$${∇}_{{ϕ}^{h}} J ( {π}_{{ϕ}^{h}} ) = {E}_{{a}^{h} ∈ {π}_{{ϕ}^{h}}} [ {∇}_{{ϕ}^{h}} log {π}_{{ϕ}^{h}} ( {s}^{h} , {a}^{h} ) {Q}_{{π}_{{ϕ}^{h}}}^{h} ( {s}^{h} , {a}^{h} ) ] \qquad ( formula 14 )$$

∇_{ϕ}_{^{h}}J(π_{ϕ}_{^{h}}) represents a second update gradient; π_{ϕ}_{^{h}} represents a random policy adopted when the second initial recommendation sub-model outputs a content recommendation result; ϕ^{h} represents a parameter of the second initial recommendation sub-model; s^{h} represents a set of sample content features involved in a process of outputting an initial content recommendation result; a^{h} represents the initial content recommendation result; and [symbol] (s^{h},a^{h}) represents a second target evaluation value.

After the second update gradient is obtained, because an optimization direction is that the greater the evaluation value, the better, the parameter of the second initial recommendation sub-model is updated according to a direction of maximizing the second update gradient. When a plurality of training samples are used for training the initial recommendation model once, the second update gradient refers to an average of a plurality of second update gradients calculated based on a plurality of second evaluation value sets corresponding to the training samples.

Step 60125: Obtain a channel loss function based on the first enhancement value set and the first evaluation value set; obtain a content loss function based on the second enhancement value set and the second evaluation value set; obtain a target loss function based on the channel loss function and the content loss function; and update a parameter of the first initial evaluation sub-model and a parameter of the second initial evaluation sub-model based on the target loss function.

The first enhancement value set includes first enhancement values respectively corresponding to sample pushed-resources. Because at least one sample pushed-resource and at least one initial channel recommendation result correspond to each other, the first enhancement values respectively corresponding to the sample pushed-resources are first enhancement values respectively corresponding to the initial channel recommendation results. The first evaluation value set includes first evaluation value respectively corresponding to initial channel recommendation results.

In one implementation, a process of obtaining a channel loss function based on the first enhancement value set and the first evaluation value set is: obtaining a first enhancement value corresponding to one initial channel recommendation result from the first enhancement value set, and obtaining a first evaluation value corresponding to the initial channel recommendation result from the first evaluation value set; obtaining a channel sub-loss function corresponding to the initial channel recommendation result based on the first enhancement value and the first evaluation value corresponding to the initial channel recommendation result; and obtaining the channel loss function based on the channel sub-loss functions respectively corresponding to the initial channel recommendation results.

For example, for an initial channel recommendation result located at the t^{th} position in the at least one initial channel recommendation result, a process of obtaining a channel sub-loss function corresponding to the initial channel recommendation result based on the first enhancement value and the first evaluation value corresponding to the initial channel recommendation result is implemented according to a formula 15 and a formula 16:

$${L}_{t} ( {θ}^{l} ) = {E}_{{s}_{t}^{l} , {r}_{t}^{l} ▯ E} [ {( {y}_{t}^{l} - {Q}_{{θ}^{l}}^{l} ( {s}_{t}^{l} , {a}_{t}^{l} ) )}^{2} ] \qquad ( formula 15 )$$

$${y}_{t}^{l} = {r}^{l} ( {s}_{t}^{l} , {a}_{t}^{l} ) + γ {Q}_{{θ}^{{l}^{′}}}^{l} ( {s}_{t + 1}^{l} , μ ( {s}_{t + 1}^{l} ) ) \qquad ( formula 16 )$$

where Lₜ(θ^{l}) represents a channel sub-loss function corresponding to the initial channel recommendation result located at the t^{th} position in the at least one initial channel recommendation result; θ^{l} and θ^{l′} represent parameters of the first initial evaluation sub-model, where θ^{l} is continuously updated in a training process, and θ^{l′} is fixed in each optimization process, and performs parameter duplication on θ^{l} after a specific quantity of training processes are completed; sₜ^{l} represents a channel feature corresponding to the initial channel recommendation result located at the t^{th} position; aₜ^{l} represents the initial channel recommendation result located at the t^{th} position; Q_{θ}_{^{l}}^{l}(sₜ^{l},aₜ^{l}) represents a first evaluation value corresponding to the initial channel recommendation result located at the t^{th} position; yₜ^{l} represents a first reference evaluation value; r^{l}(sₜ^{l},aₜ^{l}) represents a first enhancement value corresponding to the initial channel recommendation result located at the t^{th} position; γ represents a discount factor; Q_{θ}_{^{l′}}^{l}(sₜ₊₁^{l},μ(sₜ₊₁^{l})) represents a first evaluation value corresponding to an initial channel recommendation result located at the (t+1)^{th} position under the parameter θ^{l′}; sₜ₊₁^{l} represents a channel feature corresponding to the initial channel recommendation result located at the (t+1)^{th} position; and μ(sₜ₊₁^{l}) represents the initial channel recommendation result located at the (t+1)^{th} position outputted by the first initial recommendation sub-model.

After channel sub-loss functions respectively corresponding to the initial channel recommendation results are determined, the channel loss function is obtained based on the channel sub-loss functions respectively corresponding to the initial channel recommendation results. In one implementation, the terminal respectively sets weights for the channel sub-loss functions, and uses a weighted average result of the channel sub-loss functions as the channel loss function.

The second enhancement value set includes second enhancement values respectively corresponding to sample pushed-resources. Because sample pushed-resources in at least one sample pushed-resource and initial content recommendation results in at least one initial content recommendation result correspond to each other, the second enhancement values respectively corresponding to the sample pushed-resources are second enhancement values respectively corresponding to the initial content recommendation results. The second evaluation value set includes second evaluation value respectively corresponding to initial content recommendation results.

In one implementation, a process of obtaining a content loss function based on the second enhancement value set and the second evaluation value set is: obtaining a second enhancement value corresponding to one initial content recommendation result from the second enhancement value set, and obtaining a second evaluation value corresponding to the initial content recommendation result from the second evaluation value set; obtaining a content sub-loss function corresponding to the initial content recommendation result based on the second enhancement value and the second evaluation value corresponding to the initial content recommendation result; and obtaining the content loss function based on the content sub-loss functions respectively corresponding to the initial content recommendation results.

For example, for an initial content recommendation result located at the t^{th} position in the at least one initial content recommendation result, a process of obtaining a content sub-loss function corresponding to the initial content recommendation result based on the second enhancement value and the second evaluation value corresponding to the initial content recommendation result is implemented according to a formula 17 and a formula 18:

$${L}_{t} ( {θ}^{h} ) = {E}_{{s}_{t}^{h} , {r}_{t}^{h} ▯ E} [ {( {y}_{t}^{h} - {Q}_{{θ}^{h}}^{h} ( {s}_{t}^{h} , {a}_{t}^{h} ) )}^{2} ] \qquad ( formula 17 )$$

$${y}_{t}^{h} = {r}^{h} ( {s}_{t}^{h} , {a}_{t}^{h} ) + γ {Q}_{{θ}^{{h}^{′}}}^{h} ( {s}_{t + 1}^{h} , μ ( {s}_{t + 1}^{h} ) ) \qquad ( formula 18 )$$

where Lₜ(θ^{h}) represents a content sub-loss function corresponding to the initial content recommendation result located at the t^{th} position in the at least one initial content recommendation result; θ^{h} and θ^{h′} represent parameters of the second initial evaluation sub-model, where θ^{h} is continuously updated in a training process, and θ^{h′} is fixed in each optimization process, and performs parameter duplication on θ^{h} after a specific quantity of training processes are completed; sₜ^{h} represents a content feature corresponding to the initial content recommendation result located at the t^{th} position; aₜ^{h} represents the initial content recommendation result located at the t^{th} position; Q_{θ}_{^{h}}^{h}(sₜ^{h},aₜ^{h}) represents a second evaluation value corresponding to the initial content recommendation result located at the t^{th} position; yₜ^{h} represents a second reference evaluation value; r^{h}(sₜ^{h},aₜ^{h}) represents a second enhancement value corresponding to the initial content recommendation result located at the t^{th} position; γ represents a discount factor; Q_{θ}_{^{h′}}^{h}(sₜ₊₁^{h},μ(sₜ₊₁^{h})) represents a second evaluation value corresponding to an initial content recommendation result located at the (t+1)^{th} position under the parameter θ^{h′}; sₜ₊₁^{h} represents a content feature corresponding to the initial content recommendation result located at the (t+1)^{th} position; and μ(sₜ₊₁^{h}) represents the initial content recommendation result located at the (t+1)^{th} position outputted by the second initial recommendation sub-model.

After content sub-loss functions respectively corresponding to the initial content recommendation results are determined, the content loss function is obtained based on the content sub-loss functions respectively corresponding to the initial content recommendation results. In one implementation, the terminal respectively sets weights for the content sub-loss functions, and uses a weighted average result of the content sub-loss functions as the content loss function.

After the channel loss function and the content loss function are determined, a target loss function based on the channel loss function and the content loss function. In one implementation, a process of obtaining a target loss function is obtained based on the channel loss function and the content loss function is implemented based on a formula 19:

$$L = {λ}_{t} L ( {θ}^{l} ) + {λ}_{h} L ( {θ}^{h} ) \qquad ( formula 19 )$$

where L represents a target loss function; L(θ^{l}) represents a channel loss function; L(θ^{h}) represents a content loss function; λₜ represents a weight of the channel loss function; and λₕ represents a weight of the content loss function.

After the target loss function is obtained, a parameter of the first initial evaluation sub-model and a parameter of the second initial evaluation sub-model based on the target loss function are updated. When a plurality of training samples are used for training the initial recommendation model once, the target loss function refers to an average result of a plurality of target loss function obtained based on the training samples.

Each time step 60121 to step 60125 are performed, a training process of the initial recommendation model is completed. A training process of a recommendation model is an iterative process, and each time the training process is completed, whether a training termination condition is met is determined. When the training termination condition is not met, training of the recommended model is continued according to step 60121 to step 60125. Until the training termination condition is met, the recommendation model obtained when the training termination condition is met is used as the target recommendation model. In one implementation, meeting the training termination condition includes, but is not limited to, the following three cases:

Case 1. A quantity of times of iterative training reaches a quantity of times threshold.

The quantity of times threshold is set according to experience, or is flexibly adjusted according to an application scenario, which is not limited in the embodiments of this application.

Case 2. A target loss function is less than a loss threshold.

Case 3. All target loss functions converge.

That the target loss function converges means that as a quantity of times of iterative training increases, in results of a reference quantity of times of training, a fluctuation range of the target loss function falls within a reference range. For example, assuming that the reference range is −10⁻³ to 10⁻³, the reference quantity of times of is 10. If the fluctuation range of the target loss function falls within −10⁻³ to 10⁻³ in results of the 10 times of iterative training, it is considered that the target loss function converges.

When any one of the following cases is met, it is considered that the training process of the model meets the training termination condition, the recommendation model obtained at this time is used as the target recommendation model.

In one implementation, in a process of obtaining the target loss function configured to update the parameters of the first initial evaluation sub-model and the second initial evaluation sub-model, in addition to obtaining the channel loss function and the content loss function, another loss function may be further obtained, to further improve the effect of updating the parameters of the models.

In one implementation, the training sample further includes at least one sample pushed-resource. After the obtaining a channel loss function and a content loss function, the method further includes: obtaining at least one of a CTR loss function or a similarity loss function based on the at least one initial content recommendation result and the at least one sample pushed-resource in the training sample. The CTR loss function is configured to make resources pushed based on models have better CTRs, and the similarity loss function is configured to make resources pushed based on models closer to the sample pushed-resource.

For example, initial content recommendation results in the at least one initial content recommendation result are sequentially arranged, sample pushed-resources in the at least one sample pushed-resource are sequentially arranged, and an initial content recommendation result and a sample pushed-resource that are located at the same arrangement position correspond to each other. In one implementation, a process of obtaining at least one of a CTR loss function or a similarity loss function based on the at least one initial content recommendation result and the at least one sample pushed-resource in the training sample is: obtaining the at least one of the CTR loss function or the similarity loss function based on the initial recommendation results sequentially arranged in the at least one initial recommendation result and the sample pushed-resource sequentially arranged in the at least one sample pushed-resource.

In one implementation, a process of obtaining a CTR loss function is implemented based on a formula 20:

$${L}_{c} = - {\sum }_{( u , \hat{d} ) ∈ C} log ( f ( a , \hat{d} ) ) - {\sum }_{( u , \hat{d} ) ∉ C} log ( 1 - f ( a , \hat{d} ) ) \qquad ( formula 20 )$$

L_{c} represents a CTR loss function; (u,\hat{d})∈C represents that a sample pushed-resource \hat{d} is clicked/tapped by an interaction object; (u,\hat{d})∉C represents that a sample pushed-resource \hat{d} is not clicked/tapped by an interaction object; f(a,\hat{d}) represents a CTR predicted based on an initial recommendation result a and a sample pushed-resource \hat{d} corresponding to the initial recommendation result; and a calculation formula of f(a,\hat{d}) is shown in a formula 21:

$$f ( a , \hat{d} ) = σ ( {w}_{f} \cdot concat ( a , d ) + {b}_{f} ) \qquad ( formula 21 )$$

where w_{f} represents a weight vector, and b_{f} represents a bias; σ represents sigmoid (S-type) function; d represents a conversion result corresponding to the sample pushed-resource \hat{d} and having a same presentation form as the initial recommendation result a, where for example, when the presentation form of the initial recommendation result a is a feature vector, d represents a feature vector corresponding to the sample pushed-resource \hat{d}; and concat represents a concatenation operation.

In one implementation, a process of obtaining a similarity loss function is implemented based on a formula 22:

$${L}_{s} = {\sum }_{( a , \hat{d} )} cosine\_sim ( a , d ) \qquad ( formula 22 )$$

where Lₛ represents a similarity loss function, and (a,\hat{d}) represents an initial content recommendation result a and a sample pushed-resource \hat{d} corresponding to the initial content recommendation result a; and cosine_sim(a,d) represents a similarity between the initial content recommendation result a and a conversion result corresponding to the sample pushed-resource \hat{d} and having a same presentation form as the initial recommendation result a.

In a case of further obtaining at least one of a CTR loss function or a similarity loss function after obtaining a channel loss function and a content loss function, the terminal obtains the target loss function based on the at least one of the CTR loss function or the similarity loss function, as well as the channel loss function and the content loss function.

In one implementation, in a case of further obtaining a CTR loss function and a similarity loss function after obtaining a channel loss function and a content loss function, the target loss function is obtained based on the CTR loss function, the similarity loss function, the channel loss function, and the content loss function. Such a process of obtaining a target loss function is implemented based on a formula 23:

$$L = {λ}_{t} L ( {θ}^{l} ) + {λ}_{h} L ( {θ}^{h} ) + {λ}_{c} {L}_{c} + {λ}_{s} {L}_{s} \qquad ( formula 23 )$$

where L represents a target loss function; L(θ^{l}) represents a channel loss function; L(θ^{h}) represents a content loss function; L_{c} represents a CTR loss function; Lₛ represents a similarity loss function; λₜ represents a weight of the channel loss function; λₕ represents a weight of the content loss function; λ_{c} represents a weight of the CTR loss function; and λₛ represents a weight of the similarity loss function.

Step 60121 to step 60125 above are merely an illustrative description of a training process of an initial recommendation model. In one implementation, in a process of train the initial recommendation model using training samples, an experience array is first obtained based on the training samples, the experience array is placed in an experience pool, and then, a reference quantity of experience arrays are randomly selected from the experience pool to update the model. The experience array includes data required for parameter updating includes, but is not limited to, an initial channel recommendation result, an initial content recommendation result, a first enhancement value set, a second enhancement value set, a first evaluation value set, a second evaluation value set, and the like obtained based on the training samples. For a process of obtaining the experience array, reference may be made to a relevant process in step 60121 to step 60123, and details are not described herein again. Such a manner can reduce adverse impact of the correlation between data sets and improve the model training effect.

After the target recommendation model is obtained, offline tests and online tests are performed on the target recommendation model and recommendation models in the related art respectively, to verify the effectiveness of the target recommendation model compared with the recommendation models in the related art.

In the offline tests, indicators for measuring the performance of a recommendation model are the area under curve (AUC) and RelaImpr (an improvement rate relative to a basic recommendation model (the LR model in the related art)), and test results are shown in Table 1:

TABLE 1

| Model | AUC | RelaImpr |
|---|---|---|
| LR | 0.7311 | 0.00% |
| FM | 0.7585 | 11.86% |
| NFM | 0.7620 | 13.37% |
| AFM | 0.7686 | 16.23% |
| Wide&Deep | 0.7801 | 21.20% |
| DeepFM | 0.7819 | 21.98% |
| AutoInt | 0.7837 | 22.76% |
| Target recommendation | 0.8097 | 34.01% |
| model | | |

Table 1, LR, FM, NFM, AFM, Wide&Deep, DeepFM, and AutoInt are all recommendation model in the related art. According to Table 1, it can be learned that the target recommendation model is significantly better than all the recommendation models in the related art in terms of the AUC, and achieves a relative improvement rate of 34.01% compared with the basic recommendation model (the LR model in the related art). The improvement of the target recommendation model mainly comes from two aspects: (1) The hierarchical recommendation structure separates a channel recommendation task and a content recommendation task, to make comprehensive pushing more precise and flexible. The trial-and-error method based on reinforcement learning also helps the target recommendation model to learn of the optimal choice efficiently. (2) The enhancement value at the content level includes enhancement values in 4 different aspects to reflect the accuracy, diversity, and novelty of a pushed resource, thereby improving the short-term and long-term experience of the interaction object from different aspects.

In the online tests, indicators for measuring the performance of a recommendation model are the CTR and the (Average Click Number Per Capita, ACN). The improvement rates relative to the basic recommendation model (the LR model in the related art) in terms of the CTR and ACN are used as test results. The test results are shown in Table 2:

TABLE 2

| Model | CTR | ACN |
|---|---|---|
| DQN (LR) | +4.17% | +3.72% |
| DQN (GRU) | +5.27% | +4.77% |
| Double-Dueling-DQN | +5.40% | +5.41% |
| DDPG | +5.80% | +7.82% |
| Hierarchical DDPG | +6.07% | +10.43% |
| Target recommendation model | +6.34% | +11.67% |

In Table 2, DQN (LR), DQN (GRU), Double-Dueling-DQN, DDPG, and hierarchical DDPG are all recommendation models based on reinforcement learning in the related art. According to Table 2, it can be learned that the target recommendation model is significantly better than the recommendation models based on reinforcement learning in the related art in terms of both the CTR and ACN. The CTR measures the accuracy of pushing, while the ACN reflects a user's overall satisfaction with pushed resources. Usually, more attention is paid to the ACN because a higher ACN usually means that an interaction object is more willing to browse the pushed resources, that is, resources that conform to preferences of the interaction object better can be pushed based on the target recommendation model, thereby improving a probability of the interaction object clicks/taps the pushed resources.

After the target recommendation model is obtained, the target recommendation model can further be continuously updated based on the collected feedback from the interaction object. In a real industrial-grade pushing system, the stability of the model is one of the important factors affecting the user experience. The interaction object may passively learn how to interact effectively with the pushing system to obtain resources of interest. Such learning tends to last for a period of time, to form a stable usage habit, which is difficult to change once being established. However, in comprehensive pushing, to meet the diverse needs of the interaction object, heterogeneous resources of a plurality of channels are grouped together, which also brings instability. Any change of the channel and model can cause interference on the pushing result, which confuses the interaction object and hurts the experience of the interaction object. To evaluate the stability of the model, changes of proportions of channels corresponding to pushed resources after the model is updated are studied.

Stability tests are performed on the target recommendation model in the embodiments of this application and the DQN model in the related art. To reduce the bias caused by different times and dates, statistics of proportions of resources corresponding to a video channel and pushed based on the two models in periods of Saturday 00:00 to Sunday 23:00 in two adjacent weeks are collected. Maximum and average relative changes in the proportion of resources corresponding to the video channel and pushed based on the DQN model may reach 18.0% and 11.7%. In contrast, maximum and average relative changes in the proportion of resources corresponding to the video channel and pushed based on the target recommendation model are only 4.5% and 1.4%, and the target recommendation model is more stable. This is because the target recommendation model implements the channel recommendation task and the content recommendation task by using two recommendation models with different parameters and enhancement values. The target recommendation model can successfully learn of the channel preference of the interaction object, to smooth the trend jitter caused by the model update. With the help of the hierarchical reinforcement learning architecture, the target recommendation model remains stable in a model updating process without confusing the cognition and usage habits of the interaction object, so as to increase the stickiness of the interaction object, and make the CTRs of the pushed resources relatively high, which is beneficial to enhancing the long-term experience of the interaction object.

In the embodiments of this application, the channel recommendation task and the content recommendation task are implemented using two recommendation models with different parameters and enhancement values, and the accuracy, diversity, and novelty of pushing results are improved by designing various loss functions and enhancement values. The target recommendation model obtained based on such a training manner pushes resources for the interaction object, which can improve the resource pushing effect, make the CTRs of the pushed resources relatively high, and bring better long-term and short-term experience to the interaction object.

Step 602: Obtain at least one target resource from the candidate resource set based on the target recommendation model and the preference feature.

After the target recommendation model is obtained based on step 601, at least one target resource is obtained from the candidate resource set based on the target recommendation model and the preference feature. For example, the target recommendation model includes a first target recommendation model and a second target recommendation model. The first target recommendation model is configured to obtain a channel recommendation result based on the channel preference feature, and the second target recommendation model is configured to obtain a content recommendation result based on the content preference feature.

In one implementation, an implementation of obtaining at least one target resource from the candidate resource set based on the target recommendation model and the preference feature is: obtaining at least one target channel from a candidate channel set based on a first target recommendation model and the channel preference feature, one candidate resource corresponding to one candidate channel, and the candidate channel set including candidate channels corresponding to candidate resources in the candidate resource set; and obtaining the at least one target resource from the candidate resource set based on a second target recommendation model and the content preference feature and the at least one target channel.

In an exemplary embodiment, a process of obtaining at least one target channel from a candidate channel set based on a first target recommendation model and the channel preference feature is: obtaining at least one channel recommendation result based on the first target recommendation model and a channel preference feature corresponding to the target object; and using a channel in the candidate channel set matching the at least one channel recommendation result as the target channel. In an exemplary embodiment, a process of obtaining the at least one target resource from the candidate resource set based on a second target recommendation model and the content preference feature and the at least one target channel is: obtaining at least one content recommendation result based on the second target recommendation model and a content preference feature corresponding to the target object; and using a resource in the candidate resource set corresponding to the target object matching the at least one content recommendation result and corresponding to the at least one target channel as the target resource.

In another possible implementation, an implementation of obtaining at least one target resource from the candidate resource set based on the target recommendation model and the preference feature is: obtaining at least one target content from a candidate content set based on a second target recommendation model and the content preference feature, one candidate resource corresponding to one candidate content, and the candidate content set including candidate contents corresponding to candidate resources in the candidate resource set; and obtaining the at least one target resource from the candidate resource set based on a first target recommendation model, the channel preference feature, and the at least one target content.

In an exemplary embodiment, a process of obtaining at least one target content from a candidate content set based on a second target recommendation model and the content preference feature is: obtaining at least one content recommendation result based on the second target recommendation model and a content preference feature corresponding to the target object; and using a content in the candidate content set matching at least one content recommendation result as a target content. In an exemplary embodiment, a process of obtaining the at least one target resource from the candidate resource set based on a first target recommendation model, the channel preference feature, and the at least one target content is: obtaining at least one channel recommendation result based on the first target recommendation model and the channel preference feature; and using a resource in the candidate resource set matching the at least one channel recommendation result and corresponding to the at least one target content as the target resource.

Step 603: Push the at least one target resource to the target object.

For an implementation process of step 603, reference may be made to step 303 in the embodiment shown in FIG. 3, and details are not described herein again.

In the embodiments of this application, at least one target resource is obtained and pushed to a target object based on the target recommendation model and a preference feature including a channel preference feature and a content preference feature. In such a resource pushing process, the channel preference feature reflects channel information, and the content preference feature reflects content information. The resource pushing process integrates preferences of the target object in different dimensions, so that the target resource pushed to the target object not only conforms to channel preferences of the target object, but also conforms to content references of the target object, which is beneficial to improving the resource pushing effect, and further increasing the CTRs of the pushed resources.

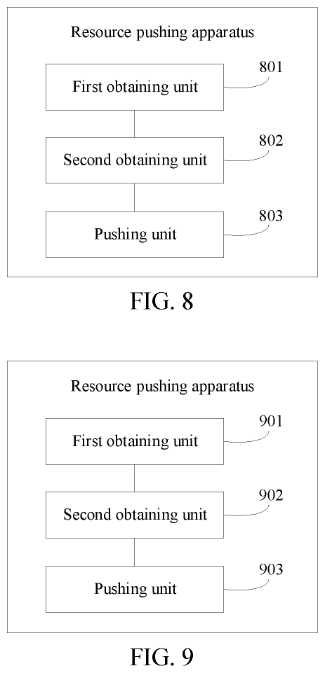

Referring to FIG. 8, the embodiments of this application provide a resource pushing apparatus. The apparatus includes:

a first obtaining unit 801, configured to obtain a preference feature and a candidate resource set corresponding to a target object, the preference feature including at least a channel preference feature and a content preference feature, and the candidate resource set including at least one candidate resource;

a second obtaining unit 802, configured to obtain at least one target resource from the candidate resource set based on the preference feature; and

a pushing unit 803, configured to push the at least one target resource to the target object.

In one implementation, the second obtaining unit 802 is configured to obtain at least one target channel from a candidate channel set based on the channel preference feature, one candidate resource corresponding to one candidate channel, and the candidate channel set including candidate channels corresponding to candidate resources in the candidate resource set; and obtain the at least one target resource from the candidate resource set based on the content preference feature and the at least one target channel.

In one implementation, the second obtaining unit 802 is configured to obtain at least one target content from a candidate content set based on the content preference feature, one candidate resource corresponding to one candidate content, and the candidate content set including candidate contents corresponding to candidate resources in the candidate resource set; and obtain the at least one target resource from the candidate resource set based on the channel preference feature and the at least one target content.

In one implementation, the second obtaining unit 802 is further configured to obtain at least one channel recommendation result based on the channel preference feature; and use a channel in the candidate channel set matching the at least one channel recommendation result as the target channel.

In one implementation, the second obtaining unit 802 is further configured to obtain at least one content recommendation result based on the content preference feature; and use a resource in the candidate resource set matching the at least one content recommendation result and corresponding to the at least one target channel as the target resource.

In one implementation, the second obtaining unit 802 is further configured to input the channel preference feature into a first target recommendation model, to obtain a channel recommendation result outputted by the first target recommendation model; obtain, in response to that a quantity of currently obtained channel recommendation results is less than a reference quantity, an updated channel preference feature based on the currently obtained channel recommendation result, and input the updated channel preference feature into the first target recommendation model, to obtain a new channel recommendation result outputted by the first target recommendation model; and repeat the operations until the quantity of the currently obtained channel recommendation results reaches the reference quantity.

In one implementation, the second obtaining unit 802 is further configured to input the content preference feature into a second target recommendation model, to obtain a content recommendation result outputted by the second target recommendation model; obtain, in response to that a quantity of currently obtained content recommendation results is less than the reference quantity, an updated content preference feature based on the currently obtained content recommendation result, and input the updated content preference feature into the second target recommendation model, to obtain a new content recommendation result outputted by the second target recommendation model; and repeat the operations until the quantity of the currently obtained content recommendation results reaches the reference quantity.

In one implementation, the first obtaining unit 801 is configured to obtain at least one historical pushed resource corresponding to the target object; obtain a channel feature sequence and a content feature sequence based on the at least one historical pushed resource; process the channel feature sequence, to obtain a channel preference feature corresponding to the target object; and process the content feature sequence, to obtain a content preference feature corresponding to the target object.

In one implementation, the first obtaining unit 801 is further configured to obtain basic information, channel information, and content information corresponding to the historical pushed resource; perform fusion processing on the basic information and channel information corresponding to the historical pushed resource, to obtain a channel feature corresponding to the historical pushed resource; perform fusion processing on the basic information and content information corresponding to the historical pushed resource, to obtain a content feature corresponding to the historical pushed resource; arrange, according to an arrangement order of historical pushed resources, channel features respectively corresponding to the historical pushed resources, to obtain the channel feature sequence; and arrange, according to the arrangement order of the historical pushed resources, content features respectively corresponding to the historical pushed resources, to obtain the content feature sequence.

In the embodiments of this application, at least one target resource is obtained and pushed to a target object based on a preference feature including a channel preference feature and a content preference feature. In such a resource pushing process, the channel preference feature reflects channel information, and the content preference feature reflects content information. The resource pushing process integrates preferences of the target object in different dimensions, so that the target resource pushed to the target object not only conforms to channel preferences of the target object, but also conforms to content references of the target object, which is beneficial to improving the resource pushing effect, and further increasing the CTRs of the pushed resources.

Referring to FIG. 9, the embodiments of this application provide a resource pushing apparatus. The apparatus includes:

a first obtaining unit 901, configured to obtain a target recommendation model and a preference feature and a candidate resource set corresponding to a target object, the preference feature including at least a channel preference feature and a content preference feature, the target recommendation model including a first target recommendation model and a second target recommendation model, and the candidate resource set including at least one candidate resource;

a second obtaining unit 902, configured to obtain at least one target resource from the candidate resource set based on the target recommendation model and the preference feature; and

a pushing unit 903, configured to push the at least one target resource to the target object.

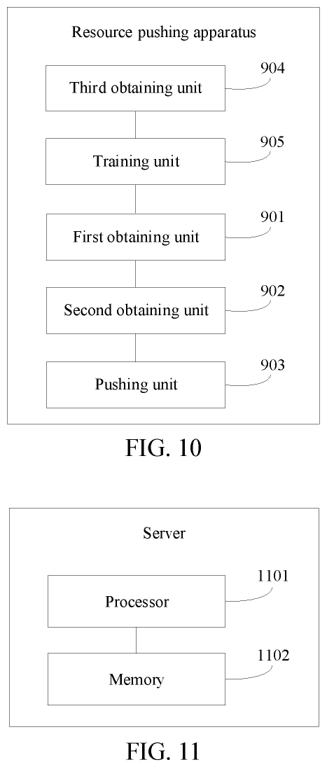

In one implementation, referring to FIG. 10, the apparatus further includes:

a third obtaining unit 904, configured to obtain a training sample set, the training sample set including at least one training sample, the training sample including a sample channel feature, a sample content feature, and feedback information corresponding to at least one sample pushed-resource; and

a training unit 905, configured to train an initial recommendation model based on the sample channel feature, the sample content feature, and the feedback information in the training sample, to obtain the target recommendation model, the initial recommendation model including a first initial recommendation model and a second initial recommendation model.

In one implementation, the first initial recommendation model includes a first initial recommendation sub-model and first initial evaluation sub-model, and the second initial recommendation model includes a second initial recommendation sub-model and a second initial evaluation sub-model. The training unit 905 is configured to obtain a first enhancement value set and a second enhancement value set based on the feedback information in the training sample; obtain at least one initial channel recommendation result based on the sample channel feature in the training sample and the first initial recommendation sub-model; obtain a first evaluation value set for the at least one initial channel recommendation result based on the first initial evaluation sub-model; obtain at least one initial content recommendation result based on the sample content feature in the training sample and the second initial recommendation sub-model; obtain a second evaluation value set for the at least one initial content recommendation result based on the second initial evaluation sub-model; update a parameter of the first initial recommendation sub-model based on the first evaluation value set; update a parameter of the second initial recommendation sub-model based on the second evaluation value set; obtain a channel loss function based on the first enhancement value set and the first evaluation value set; obtain a content loss function based on the second enhancement value set and the second evaluation value set; obtain a target loss function based on the channel loss function and the content loss function; and update a parameter of the first initial evaluation sub-model and a parameter of the second initial evaluation sub-model based on the target loss function.

In one implementation, the training sample further includes at least one sample pushed-resource. The training unit 905 is further configured to obtain at least one of a CTR loss function or a similarity loss function based on the at least one initial content recommendation result and the at least one sample pushed-resource in the training sample; and obtain the target loss function based on the at least one of the CTR loss function or the similarity loss function, as well as the channel loss function and the content loss function.

In one implementation, the training unit 905 is further configured to obtain at least one of reading duration information, diversity information, or novelty information of the sample pushed-resource and click/tap information of the sample pushed-resource based on the feedback information in the training sample; obtain a first enhancement value corresponding to the sample pushed-resource based on the click/tap information of the sample pushed-resource; obtain a second enhancement value corresponding to the sample pushed-resource based on the at least one of the reading duration information, the diversity information, or the novelty information of the sample pushed-resource and the click/tap information of the sample pushed-resource; use a set of first enhancement values respectively corresponding to sample pushed-resources as the first enhancement value set; and use a set of second enhancement value respectively corresponding to the sample pushed-resources as the second enhancement value set.

In one implementation, the second obtaining unit 902 is configured to obtain at least one target channel from a candidate channel set based on the first target recommendation model and the channel preference feature, one candidate resource corresponding to one candidate channel, and the candidate channel set including candidate channels corresponding to candidate resources in the candidate resource set; and obtain the at least one target resource from the candidate resource set based on a second target recommendation model and the content preference feature and the at least one target channel.

In one implementation, the second obtaining unit 902 is configured to obtain at least one target content from a candidate content set based on the second target recommendation model and the content preference feature, one candidate resource corresponding to one candidate content, and the candidate content set including candidate contents corresponding to candidate resources in the candidate resource set; and obtain the at least one target resource from the candidate resource set based on a first target recommendation model, the channel preference feature, and the at least one target content.

In the embodiments of this application, at least one target resource is obtained and pushed to a target object based on the target recommendation model and a preference feature including a channel preference feature and a content preference feature. In such a resource pushing process, the channel preference feature reflects channel information, and the content preference feature reflects content information. The resource pushing process integrates preferences of the target object in different dimensions, so that the target resource pushed to the target object not only conforms to channel preferences of the target object, but also conforms to content references of the target object, which is beneficial to improving the resource pushing effect, and further increasing the CTRs of the pushed resources.

When the apparatus provided in the foregoing embodiments implements functions of the apparatus, the division of the foregoing functional modules is merely an example for description. In the practical application, the functions are assigned to and completed by different functional modules according to the requirements, that is, the internal structure of the apparatus is divided into different functional modules, to implement all or some of the functions described above. In addition, the apparatus and method embodiments provided in the foregoing embodiments belong to the same conception. For the specific implementation process, reference may be made to the method embodiments, and details are not described herein again.

FIG. 11 is a schematic structural diagram of a server according to an embodiment of this application. The server may vary greatly because a configuration or performance varies, and may include one or more central processing units (CPU) 1101 and one or more memories 1102. The one or more memories 1102 store at least one piece of program code, and the at least one piece of program code is loaded and executed by the one or more processors 1101 to implement the resource pushing method provided in the foregoing various method embodiments.

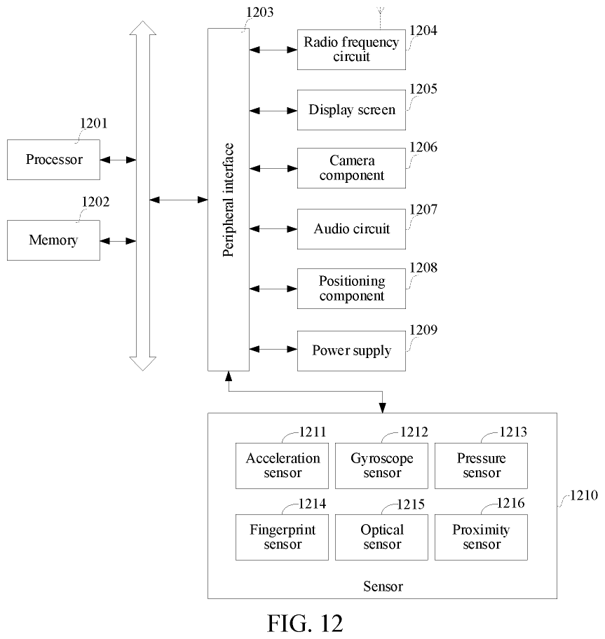

FIG. 12 is a schematic structural diagram of a terminal according to an embodiment of this application. For example, the terminal is a smartphone, a tablet computer, a notebook computer, or a desktop computer. The terminal may also be referred to as user equipment, a portable terminal, a laptop terminal, or a desktop terminal, among other names.

For example, the terminal includes a processor 1201 and a memory 1202.

The processor 1201 may include one or more processing cores, for example, a 4-core processor or an 8-core processor. The processor 1201 may be implemented by using at least one hardware form of a digital signal processor (DSP), a field-programmable gate array (FPGA), and a programmable logic array (PLA). The processor 1201 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1201 may be integrated with a graphics processing unit (GPU). The GPU is configured to render and draw content that needs to be displayed on a display screen. In some embodiments, the processor 1201 further includes an AI processor. The AI processor is configured to process a computing operation related to machine learning.

The memory 1202 may include one or more computer-readable storage media. For example, the computer-readable storage medium may be non-transitory. The memory 1202 may further include a high-speed random access memory and a nonvolatile memory, for example, one or more disk storage devices or flash storage devices. In some embodiments, a non-transitory computer-readable storage medium in the memory 1202 is configured to store at least one instruction, the at least one instruction being configured to be executed by the processor 1201 to implement the resource pushing method provided in the method embodiments of this application.

In some embodiments, the terminal may further include a peripheral interface 1203 and at least one peripheral. The processor 1201, the memory 1202, and the peripheral interface 1203 may be connected by using a bus or a signal cable. Each peripheral may be connected to the peripheral interface 1203 by using a bus, a signal cable, or a circuit board. Specifically, the peripheral device includes: at least one of a radio frequency (RF) circuit 1204, a display screen 1205, a camera component 1206, an audio circuit 1207, a positioning component 1208, and a power supply 1209.

The peripheral interface 1203 may be configured to connect the at least one peripheral related to input/output (I/O) to the processor 1201 and the memory 1202. The RF circuit 1204 is configured to receive and transmit an RF signal, also referred to as an electromagnetic signal. The RF circuit 1204 communicates with a communication network and other communication devices through the electromagnetic signal. The display screen 1205 is configured to display a user interface (UI). For example, the UI includes a graph, a text, an icon, a video, or any combination thereof. The camera component 1206 is configured to capture images or videos. The audio circuit 1207 includes a microphone and a speaker. The positioning component 1208 is configured to position a current geographic location of the terminal, to implement a navigation or a location based service (LBS). The power supply 1209 is configured to supply power to components in the terminal.

In some embodiments, the terminal further includes one or more sensors 1210. The one or more sensors 1210 include, but are not limited to: an acceleration sensor 1211, a gyroscope sensor 1212, a pressure sensor 1213, a fingerprint sensor 1214, an optical sensor 1215, and a proximity sensor 1216.

The acceleration sensor 1211 can detect acceleration sizes on three coordinate shafts of a coordinate system established based on the terminal. The gyroscope sensor 1212 may detect a body direction and a rotation angle of the terminal. The pressure sensor 1213 may be disposed at a side frame of the terminal and/or a lower layer of the display screen 1205. When the pressure sensor 1213 is disposed at the side frame of the terminal, a holding signal of the user for the terminal can be detected for the processor 1201 to perform left and right hand recognition or quick operations according to the holding signal acquired by the pressure sensor 1213. When the pressure sensor 1213 is disposed on the low layer of the display screen 1205, the processor 1201 controls, according to a pressure operation of the user on the display screen 1205, an operable control on the UI.

The fingerprint sensor 1214 is configured to acquire a user's fingerprint, and the processor 1201 identifies a user's identity according to the fingerprint acquired by the fingerprint sensor 1214, or the fingerprint sensor 1214 identifies a user's identity according to the acquired fingerprint. The optical sensor 1215 is configured to acquire ambient light intensity. The proximity sensor 1216 is also referred to as a distance sensor and is generally disposed at the front panel of the terminal. The proximity sensor 1216 is configured to acquire a distance between the user and the front face of the terminal.

A person skilled in the art may understand that the structure shown in FIG. 12 does not constitute a limitation to the terminal, and the terminal may include more or fewer components than those shown in the figure, or some components may be combined, or a different component deployment may be used.

In an exemplary embodiment, a computer device is further provided, including a processor and a memory, the memory storing at least one segment of program code. The at least one segment of program code is loaded and executed by one or more processors, to cause the computer device to the resource pushing method according to any one of the foregoing.

In an exemplary embodiment, a non-transitory computer-readable storage medium is further provided, storing at least one segment of program code, the at least one segment of program code being loaded and executed by a processor of a computer device, to cause the computer device to implement the resource pushing method according to any one of the foregoing.

In some embodiments, the foregoing computer-readable storage medium may be a read-only memory (ROM), a random access memory (RAM), a compact disc ROM (CD-ROM), a magnetic tape, a floppy disk, an optical data storage device, or the like.

In an exemplary embodiment, a computer program product or a computer program is further provided, including computer instructions, the computer instructions being stored on a non-transitory computer-readable storage medium, a processor of a computer device reading the computer instructions from the non-transitory computer-readable storage medium, and the processor executing the computer instructions, to cause the computer device to implement the resource pushing method according to any one of the foregoing.

“Plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

In this specification, and the claims of this application, the terms “first”, “second”, and the like are intended to distinguish similar objects but do not necessarily indicate a specific order or sequence. It is to be understood that such used data is interchangeable where appropriate so that the embodiments of this application described here can be implemented in an order other than those illustrated or described here. The implementations described in the foregoing exemplary embodiments do not represent all implementations that are consistent with this application. On the contrary, the implementations are merely examples of apparatuses and methods that are described in detail in the appended claims and that are consistent with some aspects of this application. In this application, the term “unit” or “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A resource pushing method performed by a computer device, the method comprising:
obtaining a target recommendation model and a preference feature and a candidate resource set corresponding to a target object, the preference feature comprising at least a channel preference feature and a content preference feature, the target recommendation model comprising a first target recommendation model and a second target recommendation model, and the candidate resource set comprising at least one candidate resource;
obtaining at least one target resource from the candidate resource set based on the target recommendation model and the preference feature; and
pushing the at least one target resource to the target object.

2. The method according to claim 1, wherein before the obtaining a target recommendation model, the method further comprises:
obtaining a training sample set, the training sample set comprising at least one training sample, the training sample comprising a sample channel feature, a sample content feature, and feedback information corresponding to at least one sample pushed-resource; and
training an initial recommendation model based on the sample channel feature, the sample content feature, and the feedback information in the training sample, to obtain the target recommendation model, the initial recommendation model comprising a first initial recommendation model and a second initial recommendation model.

3. The method according to claim 2, wherein the first initial recommendation model comprises a first initial recommendation sub-model and first initial evaluation sub-model, and the second initial recommendation model comprises a second initial recommendation sub-model and a second initial evaluation sub-model; and
the training an initial recommendation model based on the sample channel feature, the sample content feature, and the feedback information in the training sample comprises:
obtaining a first enhancement value set and a second enhancement value set based on the feedback information in the training sample;
obtaining at least one initial channel recommendation result based on the sample channel feature in the training sample and the first initial recommendation sub-model; obtaining a first evaluation value set for the at least one initial channel recommendation result based on the first initial evaluation sub-model;
obtaining at least one initial content recommendation result based on the sample content feature in the training sample and the second initial recommendation sub-model; obtaining a second evaluation value set for the at least one initial content recommendation result based on the second initial evaluation sub-model;
updating a parameter of the first initial recommendation sub-model based on the first evaluation value set; updating a parameter of the second initial recommendation sub-model based on the second evaluation value set;
obtaining a channel loss function based on the first enhancement value set and the first evaluation value set; obtaining a content loss function based on the second enhancement value set and the second evaluation value set; obtaining a target loss function based on the channel loss function and the content loss function; and updating a parameter of the first initial evaluation sub-model and a parameter of the second initial evaluation sub-model based on the target loss function.

4. The method according to claim 3, wherein the training sample further comprises the at least one sample pushed-resource; and the obtaining a target loss function based on the channel loss function and the content loss function comprises:
obtaining at least one of a click-through rate (CTR) loss function or a similarity loss function based on the at least one initial content recommendation result and the at least one sample pushed-resource in the training sample; and
obtaining the target loss function based on the at least one of the CTR loss function or the similarity loss function, as well as the channel loss function and the content loss function.

5. The method according to claim 3, wherein the obtaining a first enhancement value set and a second enhancement value set based on the feedback information in the training sample comprises:
obtaining at least one of reading duration information, diversity information, or novelty information of the sample pushed-resource and click/tap information of the sample pushed-resource based on the feedback information in the training sample;
obtaining a first enhancement value corresponding to the sample pushed-resource based on the click/tap information of the sample pushed-resource;
obtaining a second enhancement value corresponding to the sample pushed-resource based on the at least one of the reading duration information, the diversity information, or the novelty information of the sample pushed-resource and the click/tap information of the sample pushed-resource;
using a set of first enhancement values respectively corresponding to sample pushed-resources as the first enhancement value set; and using a set of second enhancement value respectively corresponding to the sample pushed-resources as the second enhancement value set.

6. The method according to claim 1, wherein the obtaining at least one target resource from the candidate resource set based on the target recommendation model and the preference feature comprises:
obtaining at least one target channel from a candidate channel set based on the first target recommendation model and the channel preference feature, one candidate resource corresponding to one candidate channel, and the candidate channel set comprising candidate channels corresponding to candidate resources in the candidate resource set; and
obtaining the at least one target resource from the candidate resource set based on the second target recommendation model and the content preference feature and the at least one target channel.

7. The method according to claim 1, wherein the obtaining at least one target resource from the candidate resource set based on the target recommendation model and the preference feature comprises:
obtaining at least one target content from a candidate content set based on the second target recommendation model and the content preference feature, one candidate resource corresponding to one candidate content, and the candidate content set comprising candidate contents corresponding to candidate resources in the candidate resource set; and
obtaining the at least one target resource from the candidate resource set based on the first target recommendation model, the channel preference feature, and the at least one target content.

8. A computer device, comprising a processor and a memory, the memory storing at least one segment of program code, the at least one segment of program code being loaded and executed by the processor, to cause the computer device to implement a resource pushing method including:
obtaining a target recommendation model and a preference feature and a candidate resource set corresponding to a target object, the preference feature comprising at least a channel preference feature and a content preference feature, the target recommendation model comprising a first target recommendation model and a second target recommendation model, and the candidate resource set comprising at least one candidate resource;
obtaining at least one target resource from the candidate resource set based on the target recommendation model and the preference feature; and
pushing the at least one target resource to the target object.

9. The computer device according to claim 8, wherein before the obtaining a target recommendation model, the method further comprises:
obtaining a training sample set, the training sample set comprising at least one training sample, the training sample comprising a sample channel feature, a sample content feature, and feedback information corresponding to at least one sample pushed-resource; and
training an initial recommendation model based on the sample channel feature, the sample content feature, and the feedback information in the training sample, to obtain the target recommendation model, the initial recommendation model comprising a first initial recommendation model and a second initial recommendation model.

10. The computer device according to claim 9, wherein the first initial recommendation model comprises a first initial recommendation sub-model and first initial evaluation sub-model, and the second initial recommendation model comprises a second initial recommendation sub-model and a second initial evaluation sub-model; and
the training an initial recommendation model based on the sample channel feature, the sample content feature, and the feedback information in the training sample comprises:
obtaining a first enhancement value set and a second enhancement value set based on the feedback information in the training sample;
obtaining at least one initial channel recommendation result based on the sample channel feature in the training sample and the first initial recommendation sub-model; obtaining a first evaluation value set for the at least one initial channel recommendation result based on the first initial evaluation sub-model;
obtaining at least one initial content recommendation result based on the sample content feature in the training sample and the second initial recommendation sub-model; obtaining a second evaluation value set for the at least one initial content recommendation result based on the second initial evaluation sub-model;
updating a parameter of the first initial recommendation sub-model based on the first evaluation value set; updating a parameter of the second initial recommendation sub-model based on the second evaluation value set;
obtaining a channel loss function based on the first enhancement value set and the first evaluation value set; obtaining a content loss function based on the second enhancement value set and the second evaluation value set; obtaining a target loss function based on the channel loss function and the content loss function; and updating a parameter of the first initial evaluation sub-model and a parameter of the second initial evaluation sub-model based on the target loss function.

11. The computer device according to claim 10, wherein the training sample further comprises the at least one sample pushed-resource; and the obtaining a target loss function based on the channel loss function and the content loss function comprises:
obtaining at least one of a click-through rate (CTR) loss function or a similarity loss function based on the at least one initial content recommendation result and the at least one sample pushed-resource in the training sample; and
obtaining the target loss function based on the at least one of the CTR loss function or the similarity loss function, as well as the channel loss function and the content loss function.

12. The computer device according to claim 10, wherein the obtaining a first enhancement value set and a second enhancement value set based on the feedback information in the training sample comprises:
obtaining at least one of reading duration information, diversity information, or novelty information of the sample pushed-resource and click/tap information of the sample pushed-resource based on the feedback information in the training sample;
obtaining a first enhancement value corresponding to the sample pushed-resource based on the click/tap information of the sample pushed-resource;
obtaining a second enhancement value corresponding to the sample pushed-resource based on the at least one of the reading duration information, the diversity information, or the novelty information of the sample pushed-resource and the click/tap information of the sample pushed-resource;
using a set of first enhancement values respectively corresponding to sample pushed-resources as the first enhancement value set; and using a set of second enhancement value respectively corresponding to the sample pushed-resources as the second enhancement value set.

13. The computer device according to claim 8, wherein the obtaining at least one target resource from the candidate resource set based on the target recommendation model and the preference feature comprises:
obtaining at least one target channel from a candidate channel set based on the first target recommendation model and the channel preference feature, one candidate resource corresponding to one candidate channel, and the candidate channel set comprising candidate channels corresponding to candidate resources in the candidate resource set; and
obtaining the at least one target resource from the candidate resource set based on the second target recommendation model and the content preference feature and the at least one target channel.

14. The computer device according to claim 8, wherein the obtaining at least one target resource from the candidate resource set based on the target recommendation model and the preference feature comprises:
obtaining at least one target content from a candidate content set based on the second target recommendation model and the content preference feature, one candidate resource corresponding to one candidate content, and the candidate content set comprising candidate contents corresponding to candidate resources in the candidate resource set; and
obtaining the at least one target resource from the candidate resource set based on the first target recommendation model, the channel preference feature, and the at least one target content.

15. A non-transitory computer-readable storage medium, storing at least one segment of program code, the at least one segment of program code being loaded and executed by a processor of a computer device, to cause the computer device to implement a resource pushing method including:
obtaining a target recommendation model and a preference feature and a candidate resource set corresponding to a target object, the preference feature comprising at least a channel preference feature and a content preference feature, the target recommendation model comprising a first target recommendation model and a second target recommendation model, and the candidate resource set comprising at least one candidate resource;
obtaining at least one target resource from the candidate resource set based on the target recommendation model and the preference feature; and
pushing the at least one target resource to the target object.

16. The non-transitory computer-readable storage medium according to claim 15, wherein before the obtaining a target recommendation model, the method further comprises:
obtaining a training sample set, the training sample set comprising at least one training sample, the training sample comprising a sample channel feature, a sample content feature, and feedback information corresponding to at least one sample pushed-resource; and
training an initial recommendation model based on the sample channel feature, the sample content feature, and the feedback information in the training sample, to obtain the target recommendation model, the initial recommendation model comprising a first initial recommendation model and a second initial recommendation model.

17. The non-transitory computer-readable storage medium according to claim 16, wherein the first initial recommendation model comprises a first initial recommendation sub-model and first initial evaluation sub-model, and the second initial recommendation model comprises a second initial recommendation sub-model and a second initial evaluation sub-model; and
the training an initial recommendation model based on the sample channel feature, the sample content feature, and the feedback information in the training sample comprises:
obtaining a first enhancement value set and a second enhancement value set based on the feedback information in the training sample;
obtaining at least one initial channel recommendation result based on the sample channel feature in the training sample and the first initial recommendation sub-model; obtaining a first evaluation value set for the at least one initial channel recommendation result based on the first initial evaluation sub-model;
obtaining at least one initial content recommendation result based on the sample content feature in the training sample and the second initial recommendation sub-model; obtaining a second evaluation value set for the at least one initial content recommendation result based on the second initial evaluation sub-model;
updating a parameter of the first initial recommendation sub-model based on the first evaluation value set; updating a parameter of the second initial recommendation sub-model based on the second evaluation value set;
obtaining a channel loss function based on the first enhancement value set and the first evaluation value set; obtaining a content loss function based on the second enhancement value set and the second evaluation value set; obtaining a target loss function based on the channel loss function and the content loss function; and updating a parameter of the first initial evaluation sub-model and a parameter of the second initial evaluation sub-model based on the target loss function.

18. The non-transitory computer-readable storage medium according to claim 17, wherein the training sample further comprises the at least one sample pushed-resource; and the obtaining a target loss function based on the channel loss function and the content loss function comprises:
obtaining at least one of a click-through rate (CTR) loss function or a similarity loss function based on the at least one initial content recommendation result and the at least one sample pushed-resource in the training sample; and
obtaining the target loss function based on the at least one of the CTR loss function or the similarity loss function, as well as the channel loss function and the content loss function.

19. The non-transitory computer-readable storage medium according to claim 15, wherein the obtaining at least one target resource from the candidate resource set based on the target recommendation model and the preference feature comprises:
obtaining at least one target channel from a candidate channel set based on the first target recommendation model and the channel preference feature, one candidate resource corresponding to one candidate channel, and the candidate channel set comprising candidate channels corresponding to candidate resources in the candidate resource set; and
obtaining the at least one target resource from the candidate resource set based on the second target recommendation model and the content preference feature and the at least one target channel.

20. The non-transitory computer-readable storage medium according to claim 15, wherein the obtaining at least one target resource from the candidate resource set based on the target recommendation model and the preference feature comprises:
obtaining at least one target content from a candidate content set based on the second target recommendation model and the content preference feature, one candidate resource corresponding to one candidate content, and the candidate content set comprising candidate contents corresponding to candidate resources in the candidate resource set; and
obtaining the at least one target resource from the candidate resource set based on the first target recommendation model, the channel preference feature, and the at least one target content.
